(19) United States
(12) Patent Application Publication
(10) Pub. No.: US 2023/0021888 A1
(43) Pub. Date: Jan. 26, 2023

(54) TECHNOLOGIES FOR ADDRESS TRANSLATION CACHE RESERVATION IN OFFLOAD DEVICES

(71) Applicants: Raghunathan Srinivasan, Chandler, AZ (US); Karthik V. Narayanan, Chandler, AZ (US); Rupin H. Vakharwala, Hillsboro, OR (US)

(72) Inventors: Raghunathan Srinivasan, Chandler, AZ (US); Karthik V. Narayanan, Chandler, AZ (US); Rupin H. Vakharwala, Hillsboro, OR (US)

(21) Appl. No.: 17/958,333

(22) Filed: Oct. 1, 2022

(51) Int. Cl. G06F 12/1045

(52) U.S. Cl. CPC G06F 12/1045; G06F 2212/68

(57) ABSTRACT

Techniques for address translation cache (ATC) reservation in offload devices are disclosed. In the illustrative embodiment, a processor of a compute device sends a start ATC reservation descriptor to an offload device. The start ATC reservation descriptor includes an identifier associated with a virtual machine for which at least part of an address translation cache of the offload device should be reserved. The offload device establishes a zone in the ATC of the offload device that is reserved for address translations associated with the identifier. Such cache reservation may be used when, e.g., a priority of a task is high or there is a need for critical or important workload to have lower latency and higher throughput.

### BACKGROUND

Offload devices such as accelerators are a type of connected device or endpoint that can offload general purpose processing and execute certain workloads with additional capacity or more efficiently in terms of performance and power. Address virtualization capabilities allow for scalable, robust use of accelerators. A translation agent in an input/output memory management unit (IOMMU) can translate virtual addresses to physical addresses, allowing the offload devices to perform direct memory accesses. In some cases, the offload devices may cache memory translations in order to reduce load on the translation agent as well as reduce latency for memory operations.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a compute device with an offload device for fetching of address translations.

FIG. 2 illustrates an embodiment of an interconnect architecture including a layered stack.

FIG. 3 illustrates an embodiment of a transmitter and receiver pair for an interconnect architecture.

FIG. 4 illustrates a simplified block diagram of an environment that can be established by the computing system of FIG. 1.

FIG. 5 is a simplified block diagram of at least one embodiment of an environment that may be established by the offload device of FIG. 1.

FIG. 6 depicts one embodiment of an IOMMU capability register.

FIG. 7 depicts one embodiment of an offload device ATC capability register.

FIG. 8 depicts one embodiment of a start ATC reservation descriptor.

FIG. 9 depicts one embodiment of an ATC reservation policy register.

FIG. 10 depicts one embodiment of a stop ATC reservation descriptor.

FIGS. 11-12 are a simplified flow diagram of at least one embodiment of a method for instructing an off-load device to implement virtual machine-specific cache reservation may be performed by the compute device of FIG. 1.

FIGS. 13-16 are a simplified flow diagram of at least one embodiment of a method for implementing virtual machine-specific cache reservation on an offload device that may be executed by some or all components of the compute device of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

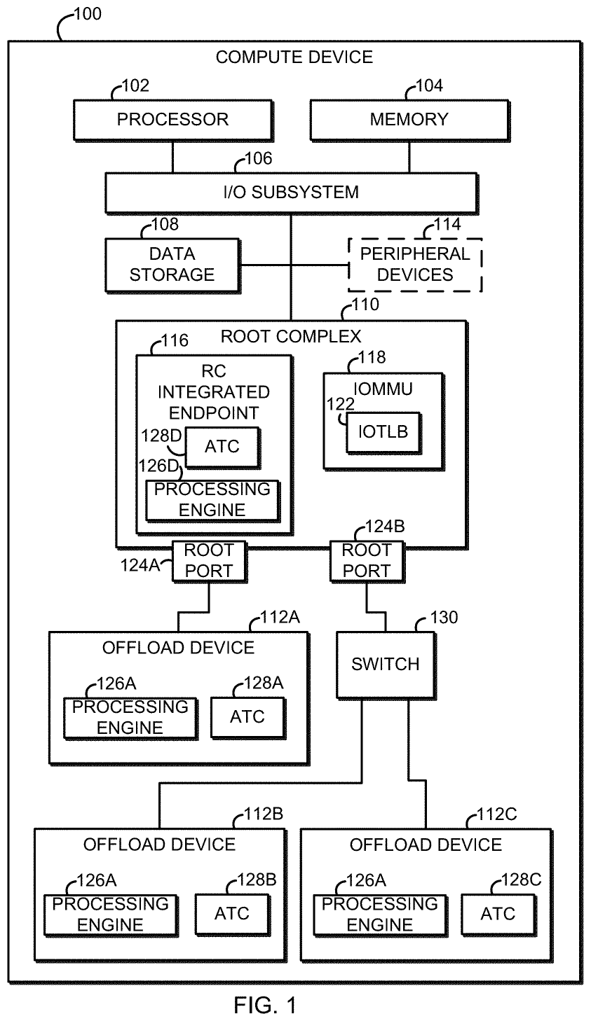

Referring now to FIG. 1, an illustrative compute device 100 is configured to offload certain tasks to one or more offload devices 112A, 112B, 112C. System software, such as an orchestrator, executing on the processor 102 can prepare and send work descriptors to the offload devices 112A, 112B, 112C. As described in more detail below, the system software can determine that a particular virtual machine or application on a virtual machine requires higher priority on one or more offload devices 112A, 112B, 112C. The system software may request the hypervisor to instruct one or more offload devices 112A, 112B, 112C to reserve at least some address translation cache for the particular virtual machine or application on the virtual machine. The hypervisor can send such a command to one or more of the offload devices 112A, 112B, 112C, which will then reserve address translation cache for address translations associated with the particular virtual machine or application. When address translations are cached, the illustrative offload devices 112 can then perform direct memory access (DMA) operations as part of performing the task corresponding to the work descriptor with little or no latency added by looking up memory address translations.

It should be appreciated that certain workloads may particularly benefit from lower-latency offloading that the present disclosure can enable. For example, if the time from work submission to work completion end-to-end latency must be extremely low, then the time spent performing memory translations should be reduced or minimized. As another example, if high performance is required for a stream of small packets, then low latency is particularly important to make sure packets can stream smoothly without large latencies between packets, causing large delays.

The compute device 100 may be embodied as any type of compute device with an offload device 112 with an address translation ache (ATC) 128 and the capability described herein. For example, the compute device 100 may be embodied as or otherwise be included in, without limitation, a server computer, an embedded computing system, a System-on-a-Chip (SoC), a multiprocessor system, a processor-based system, a consumer electronic device, a smartphone, a cellular phone, a desktop computer, a tablet computer, a notebook computer, a laptop computer, a network device, a router, a switch, a networked computer, a wearable computer, a handset, a messaging device, a camera device, and/or any other computing device. The illustrative compute device 100 includes the processor 102, a memory 104, an input/output (I/O) subsystem 106, data storage 108, a root complex 110, one or more offload devices 112A, 112B, 112C, and, optionally, one or more peripheral devices 114. In some embodiments, one or more of the illustrative components of the compute device 100 may be incorporated in, or otherwise form a portion of, another component. For example, the memory 104, or portions thereof, may be incorporated in the processor 102 in some embodiments.

The processor 102 may be embodied as any type of processor capable of performing the functions described herein. For example, the processor 102 may be embodied as a single or multi-core processor(s), a single or multi-socket processor, a digital signal processor, a graphics processor, a microcontroller, or other processor or processing/controlling circuit. Similarly, the memory 104 may be embodied as any type of volatile or non-volatile memory or data storage capable of performing the functions described herein. In operation, the memory 104 may store various data and software used during operation of the compute device 100, such as operating systems, applications, programs, libraries, and drivers. The memory 104 is communicatively coupled to the processor 102 via the I/O subsystem 106, which may be embodied as circuitry and/or components to facilitate input/output operations with the processor 102, the memory 104, and other components of the compute device 100. For example, the I/O subsystem 106 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 106 may form a portion of a system-on-a-chip (SoC) and be incorporated, along with the processor 102, the memory 104, and other components of the compute device 100 on a single integrated circuit chip.

The data storage 108 may be embodied as any type of device or devices configured for the short-term or long-term storage of data. For example, the data storage 108 may include any one or more memory devices and circuits, memory cards, hard disk drives, solid-state drives, or other data storage devices.

The illustrative root complex 110 (RC) may be, e.g., a PCIe RC or other type of device hosting system (e.g., PCI bridge). The RC 110 connects a processor and memory subsystem (e.g., the processor 102 and the memory 104) to one or more devices, such as offload devices 112A, 112B, 112C coupled to the RC 110 by a root port (RP) 124A, 124B and a multi-lane link. The RC 110 can include a root complex integrated endpoint (RCiEP) 116. In some embodiments, a switch fabric 130 can be coupled to the RC 110 via an RP 124 across a multi-lane link. The switch fabric 130 can be coupled to one or more offload devices 112 across a multi-lane link to connect the devices 112 to the RC 110.

The illustrative RC 110 is coupled to the memory 104. The memory 104 can be used by the one or more devices (such as offload devices 112A, 112B, 112C) for memory transactions, such as reads and writes, to execute jobs tasked by the processor 102 or other component of the compute device 100. The RC 110 also includes an input/output memory management unit 118 (IOMMU) that includes an input/output translation lookaside buffer 122 (IOTLB). In some embodiments, the IOMMU 118 may be referred to as or include a translation agent and/or the IOTLB 122 may be referred to, include, or form a part of an address translation and protection table (ATPT). In the illustrative embodiment, the IOMMU 118 and IOTLB 122 form part of the RC 110. Additionally or alternatively, in some embodiments, some or all of the IOMMU 118 and/or the IOTLB 122 may be a separate component from the RC 110. The IOMMU 118 can include hardware circuitry, software, or a combination of hardware and software. The IOMMU 118 and the IOTLB 122 can be used to provide address translation services (ATS) for address spaces in the memory 104 to allow one or more of the offload devices 112A, 112B, 112C to perform memory transactions to satisfy job requests issued by the host system.

The RCiEP 116 and offload devices 112A, 112B, 112C can be devices that are compliant with an interconnect protocol, such as PCIe or CXL. Examples of devices include accelerators, disk controller, network controller, graphics controller, or other type of device that is involved in streaming workloads. Each of RCiEP 116 and devices 112A, 112B, 112C can include an address translation cache 128A, 128B, 128C, 128D (ATC). Each ATC 128A, 128B, 128C, 128D can include an indexed random access memory for storing a mapping between virtual addresses and physical addresses and can index the mapping. Additionally or alternatively, each ATC 128A, 128B, 128C, 128D may be cache-hit based. Other types of memory can be used for the ATC 128A, 128B, 128C, 128D. The ATC 128A, 128B, 128C, 128D can be considered a memory element that has one or more memory element locations or entries, and each memory element location can be indexed. An index value can point to a memory element location that is allocated for or contains a virtual memory address and physical memory address translation. In some embodiments, the ATC 128A, 128B, 128C, 128D may be embodied as, may include, or may form a part of a translation fetch buffer (TPB).

In the illustrative embodiment, cache entries may be stored in each ATC 128 based on various aspects of a QoS cache reservation policy. For example, each ATC 128 may be able to be configured to reserve, e.g., 25% or 50% of its cache entries for memory translations associated with a particular identifier, such as a process address space identifier (PASID) or a domain identifier (domain ID). A domain ID may be used to identify a virtual machine, and a PASID may be used to identify a particular process or application running on a virtual machine.

Each offload device 112A, 112B, 112C includes a processing engine 126A, 126B, 126C. Similarly, the RCiEP 110 may contain a processing engine 126D. Each processing engine 126A-D may be embodied as, e.g., a processor, a memory, a graphics processing unit, an accelerator, an application specific integrated circuit (ASIC), a field programmable gate array (FPGA), and/or the like. In some embodiments, the RCiEP 110 may perform similar or the same functions as the offload devices 112A-C or may be considered or referred to as an offload device. In some embodiments, the processing engine may include circuitry to manage storing and retrieving cache entries in the ATC 128.

The root complex 110, root ports 124A and 124B, the switch fabric 130, and the links can be compliant with the PCIe protocol and/or the CXL protocol. Other interconnect protocols are also within the scope of the disclosure.

Workloads for the offload devices 112A-C may be generalized as involving reading data from memory, processing that data, and then writing the processed data back to memory. With the addition of ATS, the offload device 112 manages the translation of provided Virtual Addresses (VAs) to Physical Addresses (PAs). To read from memory, the offload device 112 first translates (or requests translation of) the provided VA to a PA and then uses that translated PA to perform a memory read. Similarly, in order to write to memory, the offload device 112 must also first translate the provided VA to a PA and then use that translated PA to write to memory.

VA can include any untranslated address including Virtual Address, Guest Physical Address, Input Output Virtual Address, etc. PA translation can include a PA translation of a requested VA, but can also include permissions. Stored in the ATC 128 are not only the VA and PA.

In some embodiments, the compute device 100 may include other or additional components, such as those commonly found in a compute device. For example, the compute device 100 may also have peripheral devices 114, such as a display, a keyboard, a mouse, etc. The display may be embodied as any type of display on which information may be displayed to a user of the compute device 100, such as a touchscreen display, a liquid crystal display (LCD), a light emitting diode (LED) display, a cathode ray tube (CRT) display, a plasma display, an image projector (e.g., 2D or 3D), a laser projector, a heads-up display, and/or other display technology.

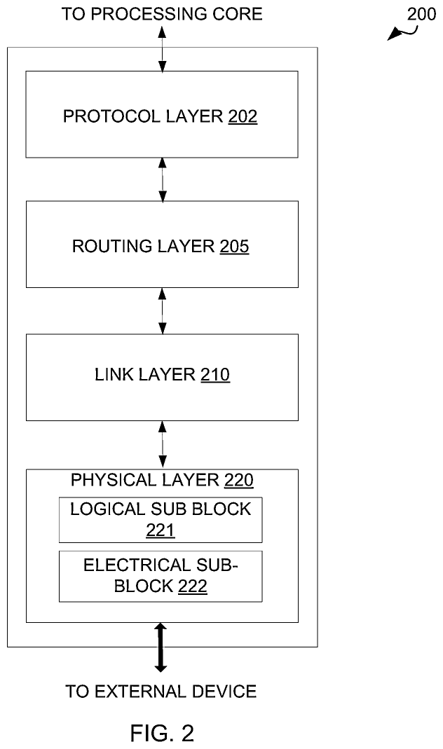

Turning to FIG. 2, an embodiment of a layered protocol stack is illustrated. Layered protocol stack 200 includes any form of a layered communication stack, such as a Quick Path Interconnect (QPI) stack, an Ultra Path Interconnect (UPI) stack, a PCIe stack, a Compute Express Link (CXL), a next generation high performance computing interconnect stack, or other layered stack. Although the discussion immediately below in reference to FIGS. 1-3 are in relation to a UPI stack, the same concepts may be applied to other interconnect stacks. In one embodiment, protocol stack 200 is a UPI protocol stack including protocol layer 202, routing layer 205, link layer 210, and physical layer 220. An interface or link, such as link 109 in FIG. 1, may be represented as communication protocol stack 200. Representation as a communication protocol stack may also be referred to as a module or interface implementing/including a protocol stack.

UPI uses packets to communicate information between components. Packets are formed in the Protocol Layer 202 to carry the information from the transmitting component to the receiving component. As the transmitted packets flow through the other layers, they are extended with additional information necessary to handle packets at those layers. At the receiving side the reverse process occurs and packets get transformed from their Physical Layer 220 representation to the Data Link Layer 210 representation and finally to the form that can be processed by the Protocol Layer 202 of the receiving device.

Protocol Layer

In one embodiment, protocol layer 202 is to provide an interface between a device's processing core and the interconnect architecture, such as data link layer 210 and physical layer 220. In this regard, a primary responsibility of the protocol layer 202 is the assembly and disassembly of packets. The packets may be categorized into different classes, such as home, snoop, data response, non-data response, non-coherent standard, and non-coherent bypass.

Routing Layer

The routing layer 205 may be used to determine the course that a packet will traverse across the available system interconnects. Routing tables may be defined by firmware and describe the possible paths that a packet can follow. In small configurations, such as a two-socket platform, the routing options are limited and the routing tables quite simple. For larger systems, the routing table options may be more complex, giving the flexibility of routing and rerouting traffic.

Link Layer

Link layer 210, also referred to as data link layer 210, acts as an intermediate stage between protocol layer 202 and the physical layer 220. In one embodiment, a responsibility of the data link layer 210 is providing a reliable mechanism for exchanging packets between two components. One side of the data link layer 210 accepts packets assembled by the protocol layer 202, applies an error detection code, i.e., CRC, and submits the modified packets to the physical layer 220 for transmission across a physical to an external device. In receiving packets, the data link layer 210 checks the CRC and, if an error is detected, instructs the transmitting device to resend. In the illustrative embodiment, CRC are performed at the flow control unit (flit) level rather than the packet level. In the illustrative embodiment, each flit is 80 bits. In other embodiments, each flit may be any suitable length, such as 16, 20, 32, 40, 64, 80, or 128 bits.

Physical Layer

In one embodiment, physical layer 220 includes logical sub block 221 and electrical sub-block 222 to physically transmit a packet to an external device. Here, logical sub-block 221 is responsible for the “digital” functions of Physical Layer 220. In this regard, the logical sub-block includes a transmit section to prepare outgoing information for transmission by physical sub-block 222, and a receiver section to identify and prepare received information before passing it to the Link Layer 210.

Physical block 222 includes a transmitter and a receiver. The transmitter is supplied by logical sub-block 221 with symbols, which the transmitter serializes and transmits onto to an external device. The receiver is supplied with serialized symbols from an external device and transforms the received signals into a bit-stream. The bit-stream is de-serialized and supplied to logical sub-block 221. In the illustrative embodiment, the physical layer 220 sends and receives bits in groups of 20 bits, called a physical unit or phit. In some embodiments, a line coding, such as an 8b/10b transmission code or a 64b/66b transmission code, is employed. In some embodiments, special symbols are used to frame a packet with frames 223. In addition, in one example, the receiver also provides a symbol clock recovered from the incoming serial stream.

As stated above, although protocol layer 202, routing layer 205, link layer 210, and physical layer 220 are discussed in reference to a specific embodiment of a QPI protocol stack, a layered protocol stack is not so limited. In fact, any layered protocol may be included/implemented. As an example, a port/interface that is represented as a layered protocol includes: (1) a first layer to assemble packets, i.e. a protocol layer; a second layer to sequence packets, i.e. a link layer; and a third layer to transmit the packets, i.e. a physical layer. As a specific example, a common standard interface (CSI) layered protocol is utilized.

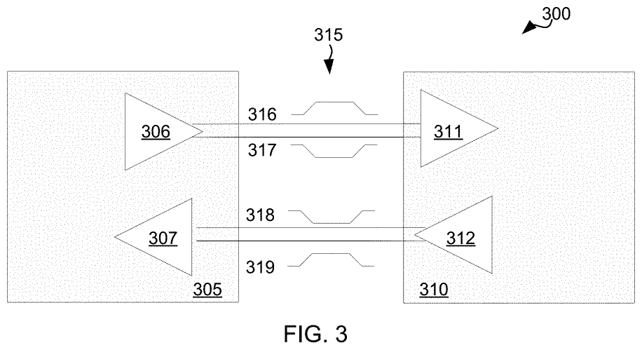

Referring next to FIG. 3, an embodiment of a UPI serial point-to-point link is illustrated. Although an embodiment of a UPI serial point-to-point link is illustrated, a serial point-to-point link is not so limited, as it includes any transmission path for transmitting serial data. In the embodiment shown, a basic UPI serial point-to-point link includes two, low-voltage, differentially driven signal pairs: a transmit pair 306/312 and a receive pair 311/307. Accordingly, device 305 includes transmission logic 306 to transmit data to device 310 and receiving logic 307 to receive data from device 310. In other words, two transmitting paths, i.e. paths 316 and 317, and two receiving paths, i.e. paths 318 and 319, are included in a UPI link.

A transmission path refers to any path for transmitting data, such as a transmission line, a copper line, an optical line, a wireless communication channel, an infrared communication link, or other communication path. A connection between two devices, such as device 305 and device 310, is referred to as a link, such as link 315. A link may support one lane—each lane representing a set of differential signal pairs (one pair for transmission, one pair for reception). To scale bandwidth, a link may aggregate multiple lanes denoted by xN, where N is any supported Link width, such as 1, 2, 4, 5, 8, 10, 12, 16, 20, 32, 64, or wider. In some implementations, each symmetric lane contains one transmit differential pair and one receive differential pair. Asymmetric lanes can contain unequal ratios of transmit and receive pairs. Some technologies can utilize symmetric lanes (e.g., UPI), while others (e.g., Displayport) may not and may even including only transmit or only receive pairs, among other examples. A link may refer to a one-way link (such as the link established by transmission logic 306 and receive logic 311) or may refer to a bi-directional link (such as the links established by transmission logic 306 and 312 and receive logic 307 and 311).

A differential pair refers to two transmission paths, such as lines 316 and 317, to transmit differential signals. As an example, when line 316 toggles from a low voltage level to a high voltage level, i.e. a rising edge, line 317 drives from a high logic level to a low logic level, i.e. a falling edge. Differential signals potentially demonstrate better electrical characteristics, such as better signal integrity, i.e. cross-coupling, voltage overshoot/undershoot, ringing, etc. This allows for better timing window, which enables faster transmission frequencies.

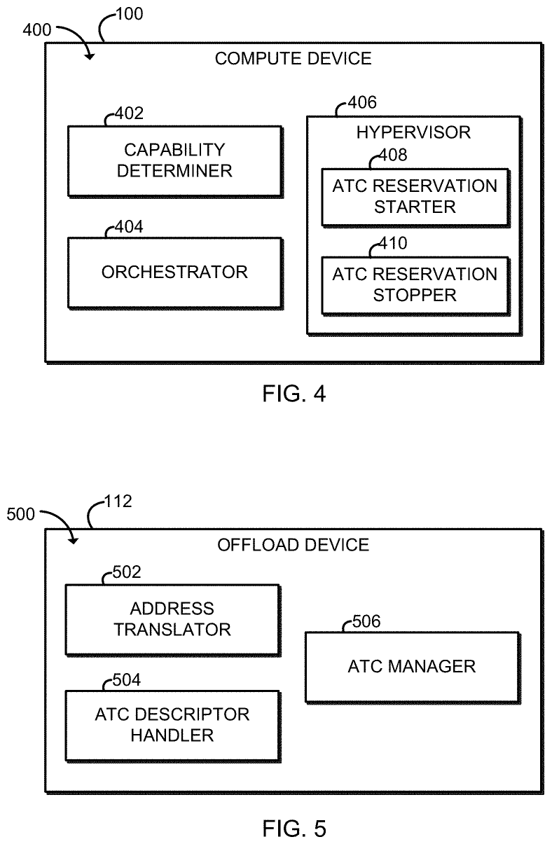

Referring now to FIG. 4, in an illustrative embodiment, the compute device 100 establishes an environment 400 during operation. The illustrative environment 400 includes a capability determiner 402, an orchestrator 404, and a hypervisor 406. The various modules of the environment 400 may be embodied as hardware, software, firmware, or a combination thereof. For example, the various modules, logic, and other components of the environment 400 may form a portion of, or otherwise be established by, the processor 102 or other hardware components of the compute device 100 such as the memory 104, the root complex 110, etc. As such, in some embodiments, one or more of the modules of the environment 400 may be embodied as circuitry or collection of electrical devices (e.g., capability determiner circuitry 402, orchestrator circuitry 404, hypervisor circuitry 406, etc.). It should be appreciated that, in such embodiments, one or more of the circuits (e.g., the capability determiner circuitry 402, the orchestrator circuitry 404, the hypervisor circuitry 406, etc.) may form a portion of one or more of the processor 102, the memory 104, the I/O subsystem 106, the data storage 108, the root complex 110, and/or other components of the compute device 100. For example, in some embodiments, some or all of the modules may be embodied as the processor 102 as well as the memory 104 and/or data storage 108 storing instructions to be executed by the processor 102. Additionally, in some embodiments, one or more of the illustrative modules may form a portion of another module and/or one or more of the illustrative modules may be independent of one another. Further, in some embodiments, one or more of the modules of the environment 400 may be embodied as virtualized hardware components or emulated architecture, which may be established and maintained by the processor 102 or other components of the compute device 100. It should be appreciated that some of the functionality of one or more of the modules of the environment 400 may require a hardware implementation, in which case embodiments of modules which implement such functionality will be embodied at least partially as hardware.

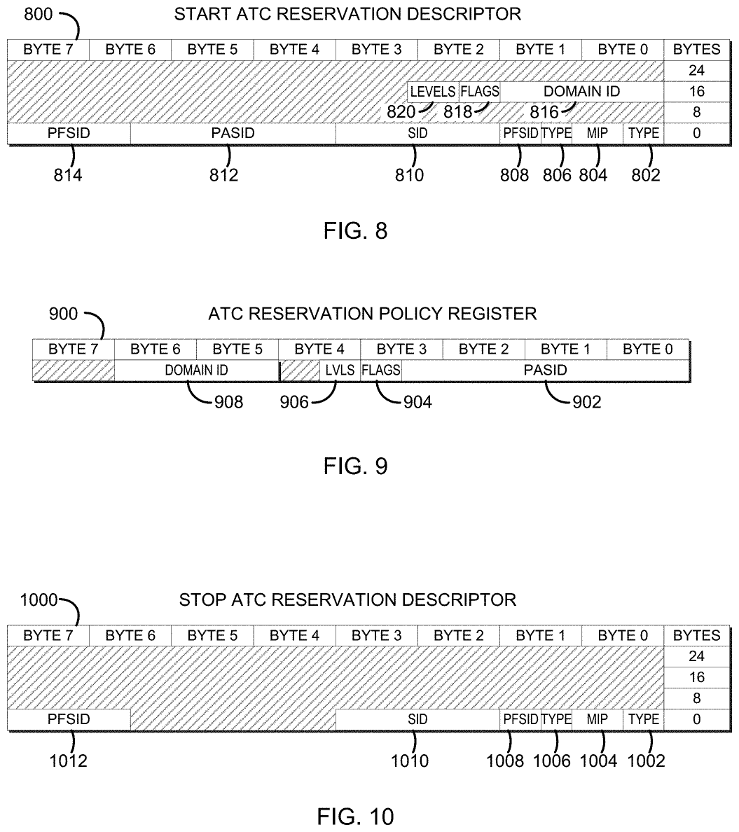

The capability determiner 402, which may be embodied as hardware, firmware, software, virtualized hardware, emulated architecture, and/or a combination thereof, as discussed above, is configured to determine the capability of the IOMMU 117 and/or the address cache capability of an offload device 112. In some embodiments, the capability determiner 402 may send a message to the IOMMU 118, requesting the capability of the IOMMU 118. The IOMMU 118 may respond with information from an IOMMU capability register 600. One embodiment of a format of an IOMMU capability register 600 is shown in FIG. 6. In the illustrative embodiment, bit 58 602 of the IOMMU capability register 600 is used to indicate whether the IOMMU 118 supports descriptors that facilitate ATC reservation. In the illustrative embodiment, bit 57 604 is reserved, and the other bits of the IOMMU capability register 600 are existing fields that are used for other purposes.

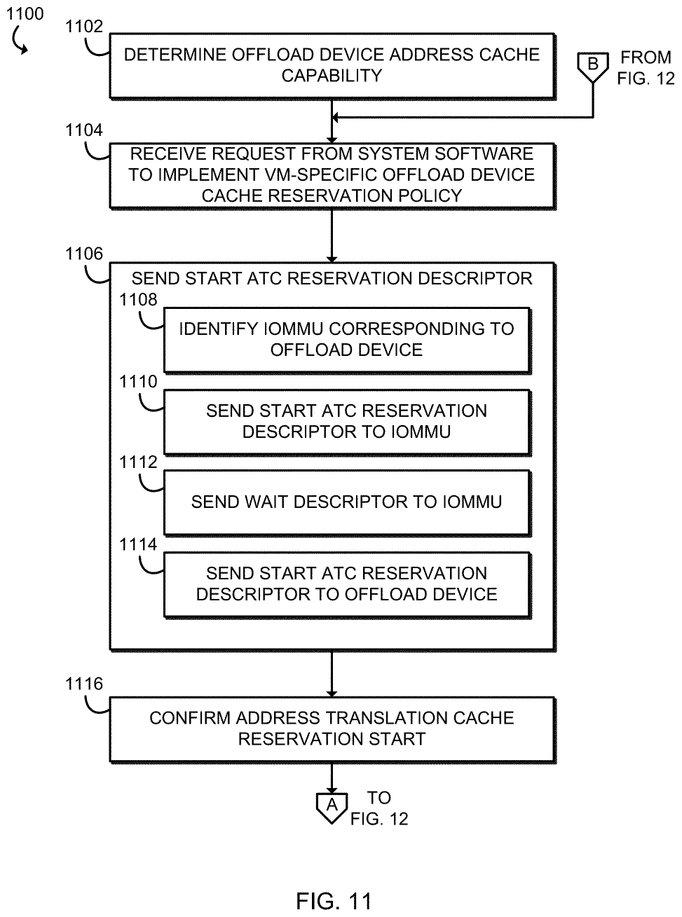

Additionally or alternatively, in some embodiments, the capability determiner 402 may send a message to one or more offload devices 112, requesting the capability of the offload devices 112. Each offload device 112 may respond with information from an offload device ATC capability register 700. One embodiment of a format of an offload device ATC capability register 700 is shown in FIG. 7. In the illustrative embodiment, bit 9 702 indicates whether domain ID-based ATC reservation is supported, and bit 8 704 indicates whether PASID ATC reservation is supported. Other bits of the offload device ATC capability register 700 may be reserved or existing fields that are used for other purposes. For example, in the illustrative embodiment, bits 0-4 706 indicate an invalidate queue depth, bit 5 708 indicates page aligned request, bit 6 710 indicates whether global invalidate is supported, and bit 712 indicates whether relaxed ordering is supported.

The orchestrator 404, which may be embodied as hardware, firmware, software, virtualized hardware, emulated architecture, and/or a combination thereof as discussed above, is configured to orchestrate the tasks and applications of the virtual machines managed by the hypervisor 406. The orchestrator 404 may determine what tasks to assign to what virtual machine and when. The orchestrator 404 may determine when a virtual machine or an application or process on a virtual machine should have reserved cache entries in an ATC 128 of an offload device 112. The orchestrator 404 may so determine based on, e.g., user input, a live migration, a priority of a task, a need for critical or important workload to have lower latency and higher throughput, and/or the like. The orchestrator 404 may send requests to the hypervisor 406 to start and stop ATC reservations.

The hypervisor 406, which may be embodied as hardware, firmware, software, virtualized hardware, emulated architecture, and/or a combination thereof, as discussed above, is configured to manage operation of the virtual machines, including scheduling time on the processor 102, scheduling operations on the offload devices 112, etc.

The hypervisor 406 includes an ATC reservation starter 408 and an ATC reservation stopper 410. The ATC reservation starter 408 may receive a request from the orchestrator 404 to implement a virtual machine (VM)-specific offload device cache reservation policy. An offload device cache reservation policy may be that, for example, a certain percentage of address translation cache is reserved for a domain ID or PASID (e.g., 25%, 50%, or any other suitable percentage), that cache entries for other domain IDs or PASIDs are preferentially evicted, and/or the like.

The ATC reservation starter 408 may send a start ATC reservation descriptor instructing the offload device 112 to begin ATC reservation. The ATC reservation starter 408 may identify an IOMMU 118 associated with the offload device 112, and the ATC reservation starter 408 may then send the start ATC reservation descriptor to the IOMMU 118 to be forwarded on to the offload device 112. The ATC reservation starter 408 may then send a wait descriptor to the IOMMU 118 to synchronize and ensure that the offload device 112 was able to execute the command. The ATC reservation starter 408 may implement an algorithm to resolve conflicts if there is a request to issue cache reservations for two or more virtual machines on a single offload device 112.

In another embodiment, the ATC reservation starter 408 may send a start ATC reservation descriptor directly to the offload device 112. Whether the ATC reservation starter 408 sends the start ATC reservation descriptor directly to the offload device 112 or to an intermediate component such as the IOMMU 118 may depend on a particular protocol in use. For example, for an ATS 1.0 protocol, the ATC reservation starter 408 may send the start ATC reservation descriptor to the IOMMU 118, while for an ATS 2.0 protocol, the ATC reservation starter 408 may send the start ATC reservation descriptor directly to the offload device 112.

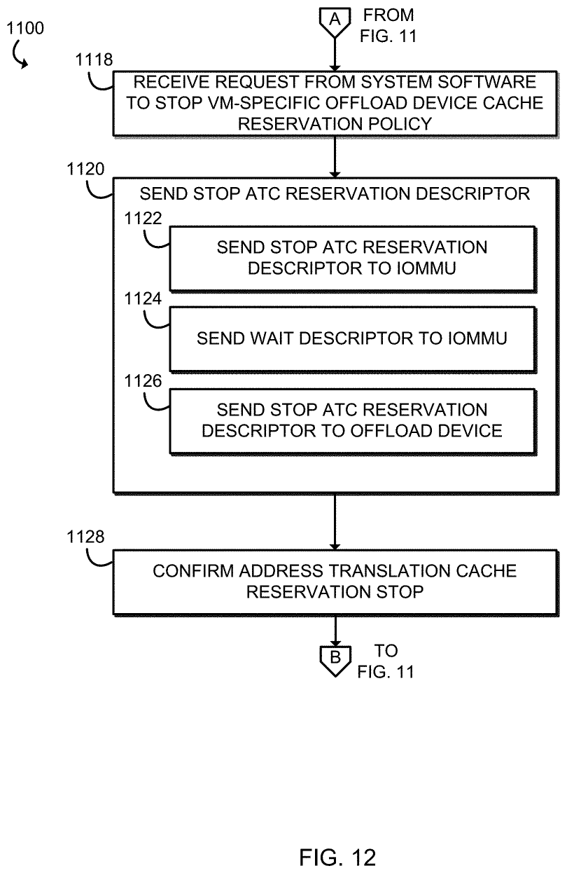

One embodiment of a start ATC reservation descriptor 800 is shown in FIG. 8. Bits 11-9 806 and bits 3-0 802 concatenated together indicate the type of the descriptor. In the illustrative embodiment, the value of the type for a start ATC reservation descriptor 800 is 0xC. Bits 8-4 804 indicate a maximum invalidations pending (MIP). Bits 15-12 808 indicate a physical function source identifier (PFSID). Bits 31-16 810 indicate a source identifier (SID) that indicates the source ID of the endpoint device 112 whose cache reservation policy is to be configured. Bits 51-32 812 indicate a PASID for which cache reservation needs to be made in the ATC 128. Bits 143-128 816 indicate a domain ID for which cache reservation needs to be made in the ATC 128. Bits 147-144 818 is a four-bit flag field with two bits that are defined and two bits that are reserved. One of the defined bits, when set, indicates that the PASID should be used to identify the address space for which cache reservation should be made, and the other of the defined bits in the flag 818, when set, indicates that the domain ID should be used to identify the address space for which cache reservation should be made. Bits 151-148 820 is a level field used to tell the offload device 112 what percentage of ATC entries should be reserved. In the illustrative embodiment, 0x4 indicates that 25% of the entries should be reserved, and 0x8 indicates that 50% of the entries should be reserved. Other values of the levels field 820 are reserved. Additional information regarding certain fields of the start ATC reservation descriptor 800 (such as the PFSID, the MIP, etc.) are available in the Intel® Virtualization Technology for Directed I/O specification v. 3.4.

It should be appreciated that the start ATC reservation descriptor 800 shown in FIG. 8 is merely one possible embodiment of a start ATC reservation descriptor 800. In the illustrative embodiment, the start ATC reservation descriptor 800 shown in FIG. 8 is compatible with ATS 1.0. In other embodiment, a start ATC reservation descriptor may be compatible with other protocols, such as a future version of ATS, such as ATS 2.0. For example, in one embodiment, a start ATS reservation descriptor may include a PASID field that is 20 bits long, which may be ignored if a flag indicating whether to use the PASID field is cleared to zero. The start ATS reservation descriptor may include a two or more bit flag field that indicates whether the PASID should be used and whether the domain ID should be used. The start ATS reservation descriptor may include an operation field with a four bit minimum. The type of the start ATS reservation descriptor may include may be 0xC to match an ATS 1.0 descriptor. The start ATS reservation descriptor may include a 64-bit field with a completion record address that specifies the address of the completion record. The start ATS reservation descriptor may include a 16-bit field for the domain ID, which may be ignored if a flag indicating whether to use the domain ID field is cleared to zero. The start ATS reservation descriptor may include a 4-bit levels field that indicates what fraction of entries of the ATC 128 should be reserved to the domain ID or PASID. The levels field may have one value, 0x4, that indicates that 25% of the entries should be reserved and one value, 0x8, that indicates that 50% of the entries should be reserved, with other values of the levels field reserved. The start ATS reservation descriptor may include a 16-bit completion interrupt handle that specifies an interrupt table entry to be used to generate a completion interrupt.

When the orchestrator 404 determines that the cache reservation can stop, such as when a task is complete or a need for priority has passed, the orchestrator 404 sends such a request to the ATC reservation stopper 410. The ATC reservation stopper 410 may send a stop ATC reservation descriptor instructing the offload device 112 to stop ATC reservation. The ATC reservation stopper 410 may send the stop ATC reservation descriptor to the IOMMU 118 to be forwarded on to the offload device 112. The ATC reservation stopper 410 may then send a wait descriptor to the IOMMU 118 to synchronize and ensure that the offload device 112 was able to execute the command.

In another embodiment, the ATC reservation stopper 410 may send a stop ATC reservation descriptor directly to the offload device 112. Whether the ATC reservation stopper 410 sends the stop ATC reservation descriptor directly to the offload device 112 or to an intermediate component such as the IOMMU 118 may depend on a particular protocol in use. For example, for an ATS 1.0 protocol, the ATC reservation stopper 410 may send the stop ATC reservation descriptor to the IOMMU 118, while for an ATS 2.0 protocol, the ATC reservation stopper 410 may send the stop ATC reservation descriptor directly to the offload device 112.

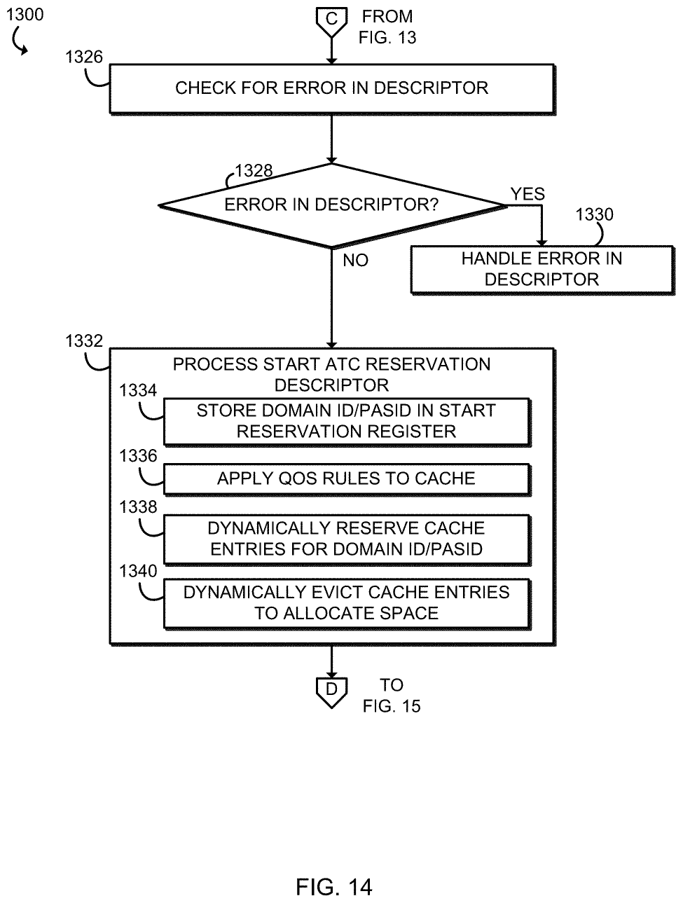

One embodiment of a stop ATC reservation descriptor 1000 is shown in FIG. 10. Bits 11-9 1006 and bits 3-0 1002 concatenated together indicate the type of the descriptor. In the illustrative embodiment, the value of the type for a stop ATC reservation descriptor 1000 is 0xD. Bits 8-4 1004 indicate a maximum invalidations pending (MIP). Bits 15-12 1008 indicate a physical function source identifier (PFSID). Bits 31-16 1010 indicate a source identifier (SID) that indicates the source ID of the endpoint device 112 whose cache reservation policy is to be configured.

It should be appreciated that the stop ATC reservation descriptor 1000 shown in FIG. 10 is merely one possible embodiment of a stop ATC reservation descriptor 1000. In the illustrative embodiment, the stop ATC reservation descriptor 1000 shown in FIG. 10 is compatible with ATS 1.0. In other embodiment, a stop ATC reservation descriptor may be compatible with other protocols, such as a future version of ATS, such as ATS 2.0. For example, in one embodiment, a stop ATS reservation descriptor may include an operation field with a four bit minimum. The type of the stop ATS reservation descriptor may include may be 0xD to match an ATS 1.0 descriptor. The stop ATS reservation descriptor may include a 64-bit field with a completion record address that specifies the address of the completion record. The stop ATS reservation descriptor may include a 16-bit completion interrupt handle that specifies an interrupt table entry to be used to generate a completion interrupt.

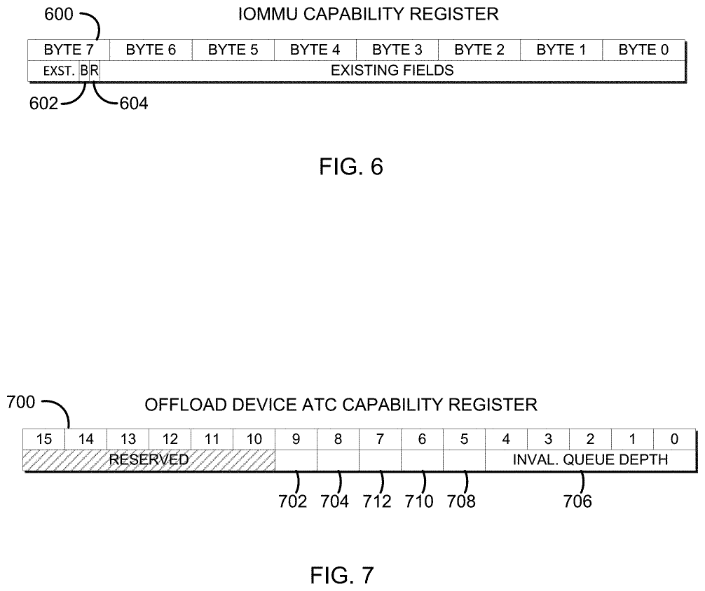

Referring now to FIG. 5, in an illustrative embodiment, the offload device 112 (or the RCiEP 116) establishes an environment 500 during operation. The illustrative environment 500 includes an address translator 502, an ATC descriptor handler 504, and an ATC manager 506. The various modules of the environment 500 may be embodied as hardware, software, firmware, or a combination thereof. For example, the various modules, logic, and other components of the environment 500 may form a portion of, or otherwise be established by, a processor or other hardware components of the offload device 112, such as the processing engine 126, memory, data storage, an FPGA, an ASIC, etc. As such, in some embodiments, one or more of the modules of the environment 500 may be embodied as circuitry or collection of electrical devices (e.g., address translator circuitry 502, ATC descriptor handler circuitry 504, ATC manager circuitry 506, etc.). It should be appreciated that, in such embodiments, one or more of the circuits (e.g., the address translator circuitry 502, the ATC descriptor handler circuitry 504, the ATC manager circuitry 506, etc.) may form a portion of one or more of a processing engine 126, a processor, memory, data storage, FPGA, ASIC, and/or other components of the offload device 112. Additionally, in some embodiments, one or more of the illustrative modules may form a portion of another module and/or one or more of the illustrative modules may be independent of one another. Further, in some embodiments, one or more of the modules of the environment 500 may be embodied as virtualized hardware components or emulated architecture, which may be established and maintained by the offload device 112. It should be appreciated that some of the functionality of one or more of the modules of the environment 500 may require a hardware implementation, in which case embodiments of modules that implement such functionality will be embodied at least partially as hardware.

The address translator 502, which may be embodied as hardware, firmware, software, virtualized hardware, emulated architecture, and/or a combination thereof as discussed above, is configured to manage memory translation requests from components of the offload device 112. When the address translator 502 receives a memory translation request, the address translator 502 determines whether the requested memory translation is available in the ATC 128. The virtual address to be translated can include any untranslated address including Virtual Address, Guest Virtual Address, Guest IO Virtual Address, Hypervisor Virtual Address, Guest Physical Address, Input Output Virtual Address, etc. If the memory translation is available in the ATC 128, the address translator 502 accesses the physical memory for the memory translation in the ATC 128 and provides it to the requesting component.

If the memory translation is not available in the ATC 128, the address translator 502 sends an address translation request to the IOMMU 118. The address translator 502 may then receive the translated address from the IOMMU 118. In the illustrative embodiment, the message with the translated address also include a PASID and/or domain ID, which can be used to identify the PASID and/or domain ID associated with entries in the ATC 128. The address translator 502 passes the translated address to the requesting component and also passes the translated address to the ATC manager 506 for caching.

The ATC descriptor handler 504, which may be embodied as hardware, firmware, software, virtualized hardware, emulated architecture, and/or a combination thereof as discussed above, is configured to handle ATC descriptors received by the offload device 112, such as start ATC reservation descriptors and stop ATC reservation descriptors.

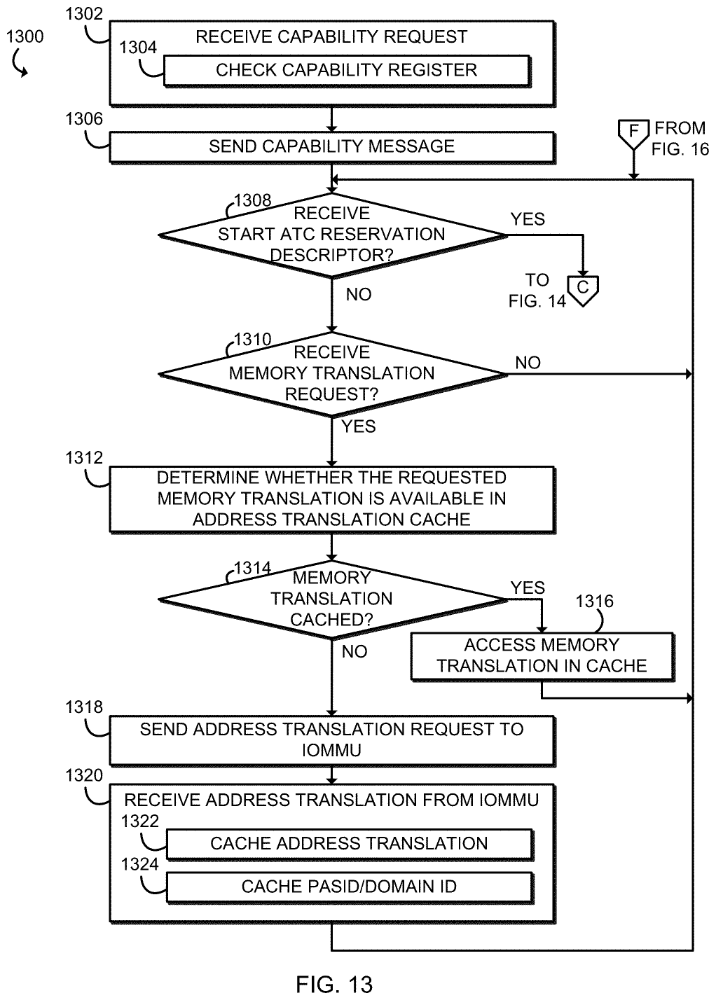

In order to process an ATC start reservation descriptor, the ATC descriptor handler 504 may store the domain ID and/or the PASID in a start reservation register, such as the ATC reservation policy register 900 shown in FIG. 9. In the illustrative embodiment, the ATC reservation policy register 900 includes the PASID in bits 19-0 902, when there is a PASID to be stored. Bits 20-23 904 include flags that indicate whether the ATC 128 should use the domain ID or PASID for the reserved part of cache. Bits 24-27 906 indicate levels that determine how much of the cache is to be reserved by the ATC 128. Bits 47-31 908 are used to store the domain ID when there is one to be stored.

The ATC descriptor handler 504 may use the flag 904 in the start ATC reservation descriptor to determine whether the domain ID or the PASID will be used to identify memory translations that should be stored in the reserved section of the cache. The ATC descriptor handler 504 may apply QoS rules to the cache. For example, in the illustrative embodiment, the ATC descriptor handler 504 may split the ATC 128 into two zones, with one zone with, e.g., 25% or 50% of the cache entries reserved for memory translations associated with the domain ID and/or the PASID. A value for the levels 820 in the start ATC reservation descriptor may be used to determine how much of the cache is reserved. In other embodiments, other QoS rules may be applied, such as preferentially evicting entries in the cache not associated with the identified domain ID or PASID and/or lengthening the residency of ache entries associated with the identified domain ID or PASID. The ATC descriptor handler 504 may dynamically evict entries in the cache to clear out space for the reserved portion of the cache.

In order to process an ATC stop reservation descriptor, the ATC descriptor handler 504 may delete the domain ID and/or the PASID from the start reservation register. The ATC descriptor handler 504 may revert cache rules to those that do not favor cache entries in a particular zone or associated with a particular domain ID or PASID. The ATC descriptor handler 504 may merge the zones of the ATC 128 into one zone. If necessary, the ATC descriptor handler 504 may dynamically evict cache entries from the previously reserved zone.

The ATC descriptor handler 504 also checks received ATC descriptors for errors. The descriptor may be considered to have an error if, e.g., the descriptor is a start ATC reservation descriptor and the offload device 112 has already started ATC reservation, the descriptor is a stop ATC reservation descriptor and the offload device 112 has not yet started ATC reservation, values in the descriptor such as levels or flags are invalid, descriptors for incompatible protocol versions were mixed (e.g., ATS 1.0 and ATS 2.0), etc.

If the ATC descriptor handler 504 handles errors when they are detected. For example, the ATC descriptor handler 504 may report the error to the IOMMU 118, which may report the error as an Invalidation Queue Error (IQE). The IOMMU 118 may store details of the IQE in an IQE Information (IQEI) hardware register that enumerates the details about what caused the IQE field to be set.

In some embodiments, the IOMMU 118 may use bits 3-0 of the IQEI hardware register to indicate error information. For example, error value 0x8 may indicate the descriptor included invalid flags. Error value 0x9 may indicate that ATS and/or ATC are not enabled. Error value 0xA may indicate that the descriptor included invalid levels. Error value 0xB may indicate that a stop ATC reservation descriptor was received without a previously issued start ATC reservation descriptor. Error value 0xC may indicate that a start ATC reservation descriptor was received when a previously issued start ATC reservation descriptor was in effect. Error value 0xD may indicate that a start ATC reservation descriptor for one version of a protocol (e.g., ATS 1.0) was received when a previously issued start ATC reservation descriptor for another version of the protocol (e.g., ATS 2.0) was in effect. Error value 0xE may indicate that a stop ATC reservation descriptor for one version of a protocol (e.g., ATS 1.0) was received when a previously issued start ATC reservation descriptor for another version of the protocol (e.g., ATS 2.0) was in effect.

In some embodiments, such as for an ATS 2.0 protocol, each descriptor may have an associated completion record, which can be used to report errors. A completion record may include a status field, an invalid flags field, and an invalid levels field. The status field may be an 8-bit field that indicates the status of a start ATC reservation descriptor or a stop ATC reservation descriptor. A value 0x0 in the status field may indicate a success. A value of 0x1 in the status field may indicate invalid flags. A value of 0x2 in the status field may indicate that ATS and ATC are not enabled. A value of 0x3 in the status field may indicate invalid levels. A value of 0x4 in the status field may indicate that a stop ATC reservation descriptor for ATS 2.0 was issued without a start ATC reservation descriptor for ATS 2.0. A value of 0x5 in the status field may indicate that a start ATC reservation descriptor for ATS 2.0 was issued while a previous start ATC reservation descriptor for ATS 2.0 was active. A value of 0x6 in the status field may indicate that a start ATC reservation descriptor for ATS 2.0 was issued while a previous start ATC reservation descriptor for ATS 1.0 was active. A value of 0x7 in the status field may indicate that a stop ATC reservation descriptor for ATS 2.0 was issued while a previous start ATC reservation descriptor for ATS 1.0 was active.

The invalid flag field, which may be two or more bits, returns a bitmask of invalid flags to aid debugging when the status field is 0x1. The invalid levels field, which may be four or more bits, provides back the invalid level passed by the ATC start reservation descriptor when the status field is 0x3.

The ATC manager 506, which may be embodied as hardware, firmware, software, virtualized hardware, emulated architecture, and/or a combination thereof, as discussed above, is configured to manage the cache in the ATC 128. When a memory translation in the ATC 128 is accessed, the ATC manager 506 may update the cache based on the accessed memory translation, such as marking the accessed memory translation as the most recently used cache entry.

When a new translated address is received, if ATC reservation is inactive, the ATC manager 506 stores the translated address in the ATC 128. The ATC manager 506 may also store a domain ID and/or PASID associated with the translated address. The domain ID and/or PASID may be included in the translated address received by the offload device 112. If the ATC reservation is active when a new translated address is received, the ATC manager 506 checks whether the received address translation is associated with the reserved zone of the ATC 128 by comparing the domain ID or PASID in the address translation with the domain ID or PASID associated with the reserved zone. If the address is not associated with the reserved zone, the ATC manager 506 caches the address translation in the unreserved zone. The ATC manager 506 may evict another entry in the ATC 128 but, in the illustrative embodiment, will not evict an entry in the reserved zone. The ATC 128 may use any suitable cache replacement algorithm, such as least recently used (LRU), first in first out (FIFO), etc. In some embodiments, the ATC manager 506 may select an internal policy for reservation/allocation of cache entries based on existing load. If the received address translation is associated with the reserved zone of the ATC 128, the ATC manager 506 caches the address translation in the reserved zone. The ATC manager 506 may evict another entry in the reserved zone of the ATC 128 to make room for the new entry. In some embodiments, the ATC manager 506 may store a new address translation associated with the reserved zone in the unreserved zone or may, after evicting a cache entry in the reserved zone, store the evicted entry in the unreserved zone, evicting another cache entry from the unreserved zone.

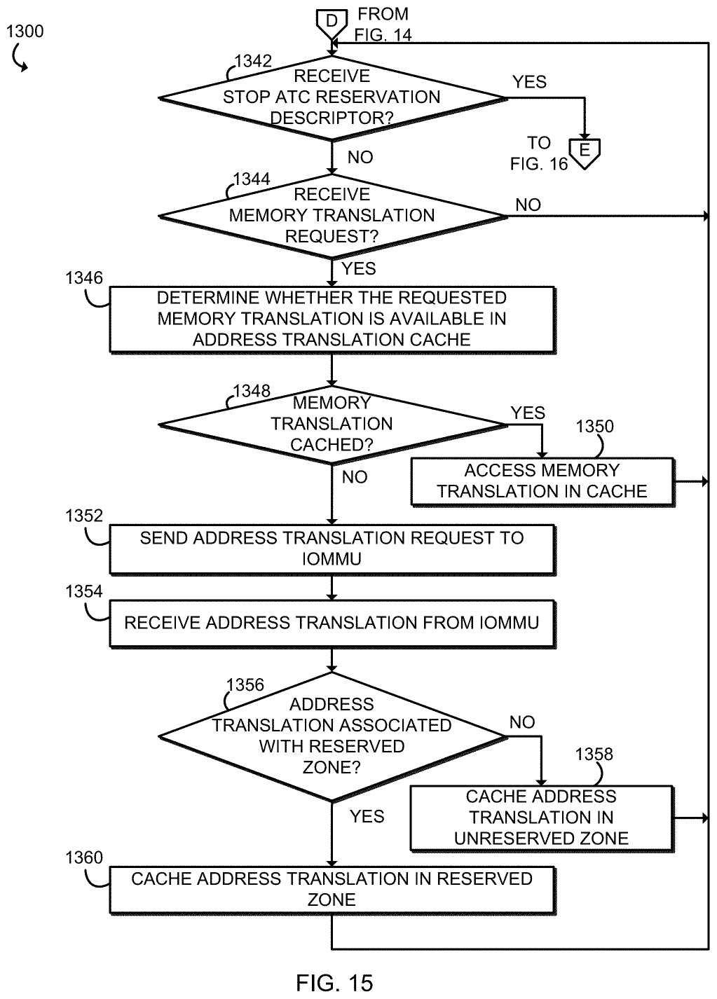

Referring now to FIG. 11, in use, the compute device 100 may execute a method 1100 for requesting offload device 112 reserve address translation cache. The method 1100 may be performed by any suitable combination of hardware, software, and/or other components of the compute device 100, such as the processor 102, the memory 104, the data storage 108, etc. The method 1100 begins in block 1102, in which the compute device 100 determines address cache capability of an offload device 112. In some embodiments, the compute device 100 sends a message to the IOMMU 118, requesting the capability of the IOMMU 118. The IOMMU 118 may respond with information from an IOMMU capability register 600, shown in FIG. 6 and described above in more detail.

Additionally or alternatively, in some embodiments, the compute device 100 sends a message to one or more offload devices 112, requesting the capability of the offload devices 112. Each offload device 112 may respond with information from an offload device ATC capability register 700, depicted in FIG. 7 and described above in more detail.

After determining the capability of the IOMMU 118 and/or the offload devices 112, the compute device 100 may receive a request from system software, such as an orchestrator, to implement a virtual machine (VM)-specific offload device cache reservation policy in block 1104. An offload device cache reservation policy may be that, for example, a certain percentage of address translation cache is reserved for a domain ID or PASID (e.g., 25%, 50%, or any other suitable percentage), that cache entries for other domain IDs or PASIDs are preferentially evicted, and/or the like. The system software may request to implement a cache reservation policy because, e.g., a user input indicated to request it, a live migration requires it, a priority of a VM or application on the VM requires it, etc.

In block 1106, the compute device 100 may send a start ATC reservation descriptor instructing the offload device 112 to begin ATC reservation. In block 1108, in some embodiments, the compute device 100 may identify an IOMMU 118 associated with the offload device 112, and the compute device 100 may then send the start ATC reservation descriptor to the IOMMU 118 to be forwarded on to the offload device 112. In block 1112, the compute device 100 may then send a wait descriptor to the IOMMU 118 to synchronize and ensure that the offload device 112 was able to execute the command.

In another embodiment, in block 1114, the compute device 100 may send a start ATC reservation descriptor directly to the offload device 112. An example start ATC reservation descriptor is shown in FIG. 8 and described in more detail above. If the offload device 112 has not received a start ATC reservation descriptor, the method 1300 proceeds to block 1310. Whether the compute device 100 sends the start ATC reservation descriptor directly to the offload device 112 or to an intermediate component such as the IOMMU 118 may depend on a particular protocol in use. For example, for an ATS 1.0 protocol, the compute device 100 may send the start ATC reservation descriptor to the IOMMU 118, while for an ATS 2.0 protocol, the compute device 100 may send the start ATC reservation descriptor directly to the offload device 112.

In block 1116, the compute device 100 confirms that ATC reservation has started. For example, the compute device 100 may receive confirmation from the IOMMU 118 and/or the offload device 112 that ATC reservation has started.

In block 1118, in FIG. 12, the compute device 100 may receive a request from system software to stop the VM-specific offload device cache reservation policy, such as when a task is complete or a need for priority has passed. In block 1120, the compute device 100 may send a stop ATC reservation descriptor instructing the offload device 112 to stop ATC reservation. In block 1122, the compute device 100 may send the stop ATC reservation descriptor to the IOMMU 118 to be forwarded on to the offload device 112. In block 1124, the compute device 100 may then send a wait descriptor to the IOMMU 118 to synchronize and ensure that the offload device 112 was able to execute the command.

In another embodiment, in block 1126, the compute device 100 may send a stop ATC reservation descriptor directly to the offload device 112. An example stop ATC reservation descriptor is shown in FIG. 10 and described in more detail above. Whether the compute device 100 sends the stop ATC reservation descriptor directly to the offload device 112 or to an intermediate component such as the IOMMU 118 may depend on a particular protocol in use. For example, for an ATS 1.0 protocol, the compute device 100 may send the stop ATC reservation descriptor to the IOMMU 118, while for an ATS 2.0 protocol, the compute device 100 may send the stop ATC reservation descriptor directly to the offload device 112.

After confirming the address translation cache reservation has stopped, the method 1100 may loop back to block 1104 in FIG. 11 to wait to receive another request to implement a VM-specific offload device cache reservation policy.

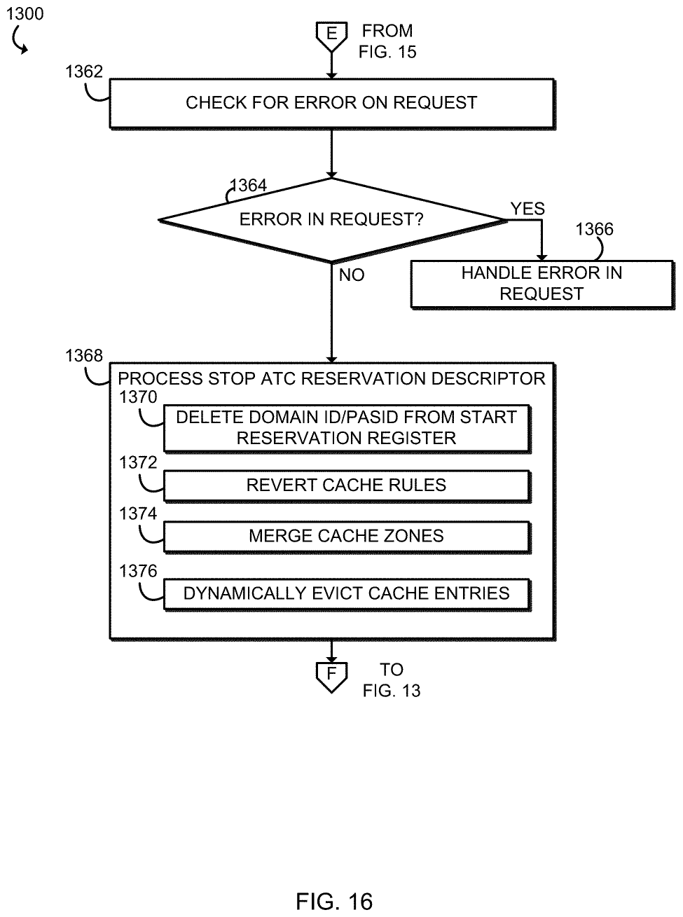

Referring now to FIG. 13, in use, an offload device 112 may execute a method 1300 reserving entries in the address translation cache (ATC) 128. The method 1300 may be performed by any suitable combination of hardware, software, firmware, and/or other components of the offload device 100, such as the processing engine 126 and/or the ATC 128. The method 1300 begins in block 1302, in which, the offload device 112 receives a request for the capability of the offload device 112. The offload device 112 may check its ATC capability register 700 in block 1304, depicted in FIG. 7 and described in more detail above. In the illustrative embodiment, bit 9 702 indicates whether domain ID-based ATC reservation is supported, and bit 8 704 indicates whether PASID ATC reservation is supported. The offload device 112 may send a capability message indicating its capability in block 1306.

In block 1308, if the offload device 112 has received a start ATC reservation descriptor, the method 1300 jumps to block 1326 in FIG. 14 to check for errors in the start ATC reservation descriptor. An example start ATC reservation descriptor is shown in FIG. 8 and described in more detail above. If the offload device 112 has not received a start ATC reservation descriptor, the method 1300 proceeds to block 1310.

In block 1310, if the offload device 112 has not received a memory translation request (e.g., from the processing engine 126 or other component of the offload device 112), the method 1300 loops back to block 1308 to check if a start ATC reservation descriptor was received. If the offload device 112 has received a memory translation request, the method 1300 proceeds to block 1312.

In block 1312, the offload device 112 determines whether the requested memory translation is available in the ATC 128. The virtual address to be translated can include any untranslated address including Virtual Address, Guest Virtual Address, Guest IO Virtual Address, Hypervisor Virtual Address, Guest Physical Address, Input Output Virtual Address, etc. In block 1314, if the memory translation is available in the ATC 128, the method 1300 proceeds to block 1316, in which the physical memory for the memory translation is accessed in the ATC 128 and provided to the requesting component. The ATC 128 may update the cache based on the accessed memory translation, such as marking the accessed memory translation as the most recently used cache entry. The method 1300 then loops back to block 1308 to check if a start ATC reservation descriptor was received.

Referring back to block 1314, if the memory translation is not available in the ATC 128, the method 1300 proceeds to block 1318, in which an address translation request is sent to the IOMMU 118. In block 1320, the offload device 112 receives the translated address from the IOMMU 118. In the illustrative embodiment, the message with the translated address also includes a PASID and/or domain ID, which can be used to identify the PASID and/or domain ID associated with entries in the ATC 128. In block 1322, the offload device 112 may update the ATC 128 based on the received translated address. In block 1324, the offload device 112 may update the ATC 128 to include the PASID and/or domain ID along with the received translated address. In order to store the translated address, the ATC 128 may evict another entry from the cache. The ATC 128 may use any suitable cache replacement algorithm, such as least recently used (LRU), first in first out (FIFO), etc.

Referring back to block 1308, if the offload device 112 has received a start ATC reservation descriptor, the method 1300 jumps to block 1326 in FIG. 14 to check for errors in the start ATC reservation descriptor. The descriptor may be considered to have an error if, e.g., the descriptor is a start ATC reservation descriptor and the offload device 112 has already started ATC reservation, the descriptor is a stop ATC reservation descriptor and the offload device 112 has not yet started ATC reservation, values in the descriptor such as levels or flags are invalid, descriptors for incompatible protocol versions were mixed (e.g., ATS 1.0 and ATS 2.0), etc.

In block 1328, if there is an error in the descriptor, the method 1300 proceeds to block 1330, in which the offload device 112 handles the error. For example, the offload device 112 may report the error to the IOMMU 118, which may report the error as an Invalidation Queue Error (IQE). The IOMMU 118 may store details of the IQE in the IQEI hardware register, as described in more detail above.

Referring back to block 1328, if there is no error in the descriptor, the method 1300 proceeds to block 1332, in which the offload device 112 processes the start ATC reservation descriptor. In block 1334, the offload device 112 may store the domain ID and/or the PASID in a start reservation register, such as the ATC reservation policy register 900 shown in FIG. 9 and described above. The offload device 112 may use a flag in the start ATC reservation descriptor to determine whether the domain ID or the PASID will be used to identify memory translations that should be stored in the reserved section of the cache. In block 1336, the offload device 112 may apply QoS rules to the cache. For example, in the illustrative embodiment, the offload device 112 may split the ATC 128 into two zones, with one zone with, e.g., 25% or 50% of the cache entries reserved for memory translations associated with the domain ID and/or the PASID in block 1338. A value for the levels 820 in the start ATC reservation descriptor may be used to determine how much of the cache is reserved. In other embodiments, other QoS rules may be applied, such as preferentially evicting entries in the cache not associated with the identified domain ID or PASID. In block 1340, entries in the cache 128 may be dynamically evicted to clear out space for the reserved portion of the cache.

In block 1342, in FIG. 15, if the offload device 112 has received a stop ATC reservation descriptor, the method 1300 jumps to block 1362 in FIG. 16 to check for errors in the stop ATC reservation descriptor. An example stop ATC reservation descriptor is shown in FIG. 10 and described in more detail above. If the offload device 112 has not received a stop ATC reservation descriptor, the method 1300 proceeds to block 1344.

In block 1344, if the offload device 112 has not received a memory translation request (e.g., from the processing engine 126 or other component of the offload device 112), the method 1300 loops back to block 1342 to check if a stop ATC reservation descriptor was received. If the offload device 112 has received a memory translation request, the method 1300 proceeds to block 1346.

In block 1346, the offload device 112 determines whether the requested memory translation is available in the ATC 128. The virtual address to be translated can include any untranslated address including Virtual Address, Guest Virtual Address, Guest IO Virtual Address, Hypervisor Virtual Address, Guest Physical Address, Input Output Virtual Address, etc. In block 1348, if the memory translation is available in the ATC 128, the method 1300 proceeds to block 1350, in which the physical memory for the memory translation is accessed in the ATC 128 and provided to the requesting component. The ATC 128 may update the cache based on the accessed memory translation, such as marking the accessed memory translation as the most recently used cache entry. The method 1300 then loops back to block 1342 to check if a stop ATC reservation descriptor was received.

Referring back to block 1348, if the memory translation is not available in the ATC 128, the method 1300 proceeds to block 1352, in which an address translation request is sent to the IOMMU 118. In block 1354, the offload device 112 receives the translated address from the IOMMU 118. In the illustrative embodiment, the message with the translated address also includes a PASID and/or domain ID, which can be used to identify the PASID and/or domain ID associated with entries in the ATC 128.

In block 1356, the offload device 112 checks whether the address translation is associated with the reserved zone of the ATC 128. If it is not, the method 1300 proceeds to block 1358, in which the address translation is cached in the unreserved zone. The offload device 112 may evict another entry in the ATC 128 but, in the illustrative embodiment, will not evict an entry in the reserved zone. The method 1300 then loops back to block 1342 to check if a stop ATC reservation descriptor was received.

Referring back to block 1356, if the address translation is associated with the reserved zone of the ATC 128, the method 1300 proceeds to block 1360, in which the address translation is cached in the reserved zone. The offload device 112 may evict another entry in the reserved zone of the ATC 128 to make room for the new entry. The method 1300 then loops back to block 1342 to check if a stop ATC reservation descriptor was received.

Referring back to block 1342, if the offload device 112 has received a stop ATC reservation descriptor, the method 1300 jumps to block 1362 in FIG. 16 to check for errors in the stop ATC reservation descriptor. The descriptor may be considered to have an error if, e.g., the descriptor is a start ATC reservation descriptor and the offload device 112 has already started ATC reservation, the descriptor is a stop ATC reservation descriptor and the offload device 112 has not yet started ATC reservation, descriptors for incompatible protocol versions were mixed (e.g., ATS 1.0 and ATS 2.0), etc.

In block 1364, if there is an error in the descriptor, the method 1300 proceeds to block 1366, in which the offload device 112 handles the error. For example, the offload device 112 may report the error to the IOMMU 118, which may report the error as an IQE. The IOMMU 118 may store details of the IQE in the IQEI hardware register, as described in more detail above.

Referring back to block 1364, if there is no error in the descriptor, the method 1300 proceeds to block 1368, in which the offload device 112 processes the stop ATC reservation descriptor. In block 1370, the offload device 112 may delete the domain ID and/or the PASID from the start reservation register. In block 1372, the offload device 112 may revert cache rules to those that do not favor cache entries in a particular zone or associated with a particular domain ID or PASID. In block 1374, the offload device 112 may merge the zones of the ATC 128 into one zone. In block 1376, if necessary, the offload device 112 may dynamically evict cache entries from the previously reserved zone. The method 1300 then loops back to block 1308 to wait for another start ATC reservation descriptor.

It should be appreciated that the embodiments described in detail above are merely some of the possible embodiments and that other embodiments are envisioned as well. For example, the compute device 100 may instruct the offload device 112 to start or stop implementation of a cache reservation policy using any suitable message(s) or message formats. The offload device 112 may implement a cache reservation policy in any suitable manner, such as by reserving some or all of the cache for address translations associated with a particular virtual machine, by preferentially evicting address translations not associated with a particular virtual machine, or otherwise implementing a cache replacement policy that favors address translations associated with a particular virtual machine.

### EXAMPLES

Illustrative examples of the technologies disclosed herein are provided below. An embodiment of the technologies may include any one or more, and any combination of, the examples described below.

Example 1 includes an offload device comprising an address translation cache (ATC); and a processing engine implemented at least partially in hardware, wherein the processing engine is to receive a start ATC reservation descriptor, wherein the start ATC reservation descriptor comprises an identifier associated with a virtual machine; receive an address translation, wherein the address translation comprises a physical address corresponding to a translation of a virtual address; determine that the address translation is associated with the identifier included in the start ATC reservation descriptor; and store the physical address in the ATC at least partially based on the determination that the address translation is associated with the identifier included in the start ATC reservation descriptor.

Example 2 includes the subject matter of Example 1, and wherein the processing engine is to send, in response to receipt of a capability request message, a message indicating that the offload device is capable of reserving at least part of the ATC for cache entries associated with the ATC.

Example 3 includes the subject matter of any of Examples 1 and 2, and wherein the identifier associated with the virtual machine comprises a domain identifier, wherein the domain identifier identifies the virtual machine.

Example 4 includes the subject matter of any of Examples 1-3, and wherein the identifier associated with the virtual machine comprises a process address space identifier (PASID), wherein the PASID identifies an application of the virtual machine.

Example 5 includes the subject matter of any of Examples 1-4, and wherein the start ATC reservation descriptor comprises one or more flags that indicate whether the identifier associated with the virtual machine is a domain identifier that identifies the virtual machine or a process address space identifier (PASID) that identifies an application of the virtual machine.

Example 6 includes the subject matter of any of Examples 1-5, and wherein, in response to receipt of the start ATC reservation descriptor, the processing engine is to store the identifier associated with the virtual machine in a register of the offload device; and establish a first zone and a second zone in the ATC, wherein the first zone is reserved for cache entries associated with the identifier.

Example 7 includes the subject matter of any of Examples 1-6, and wherein, in response to receipt of the start ATC reservation descriptor, the processing engine is to evict, from the first zone, one or more cache entries that are not associated with the identifier.

Example 8 includes the subject matter of any of Examples 1-7, and wherein the processing engine is to store the physical address in the first zone of the ATC based on the determination that the address translation is associated with the identifier included in the start ATC reservation descriptor.

Example 9 includes the subject matter of any of Examples 1-8, and wherein the processing engine is further to receive a second address translation, wherein the second address translation comprises a second physical address corresponding to a translation of a second virtual address; determine that the second address translation is not associated with the identifier included in the start ATC reservation descriptor; and store the second physical address in the second zone based on the determination that the address translation is not associated with the identifier included in the start ATC reservation descriptor.

Example 10 includes the subject matter of any of Examples 1-9, and wherein the start ATC reservation descriptor includes one or more level bits, wherein the one or more level bits indicate a fraction of the ATC that should be reserved for cache entries associated with the identifier, wherein to establish the first zone in the ATC comprises to establish the first zone in the ATC based on the one or more level bits.

Example 11 includes the subject matter of any of Examples 1-10, and wherein the one or more level bits indicate that the first zone should be 25% of the ATC.

Example 12 includes the subject matter of any of Examples 1-11, and wherein the one or more level bits indicate that the first zone should be 50% of the ATC.

Example 13 includes the subject matter of any of Examples 1-12, and wherein the processing engine in further to receive a stop ATC reservation descriptor; delete, in response to receipt of the stop ATC reservation descriptor, the identifier associated with the virtual machine from the register; and merge, in response to receipt of the stop ATC reservation descriptor, the first zone and the second zone.

Example 14 includes the subject matter of any of Examples 1-13, and wherein to store the physical address in the ATC at least partially based on the determination that the address translation is associated with the identifier included in the start ATC reservation descriptor comprises to preferentially evict a cache entry from the ATC based on a determination that the cache entry is not associated with the identifier included in the start ATC reservation descriptor.

Example 15 includes the subject matter of any of Examples 1-14, and wherein the processing engine in further to receive a second ATC reservation descriptor; determine whether the second ATC reservation descriptor triggers an error; and send a message to an input/output memory management unit (MMU) in response to a determination that the second ATC reservation descriptor triggers an error.

Example 16 includes the subject matter of any of Examples 1-15, and wherein the processing engine in further to receive a second ATC reservation descriptor; determine whether the second ATC reservation descriptor triggers an error; and send a completion record in response to receipt of the second ATC reservation descriptor, wherein the completion record includes a status code indicative of the error.

Example 17 includes a compute device comprising the offload device of any of Examples 1-16, further comprising a processor; one or more computer-readable media comprising a plurality of instructions stored thereon that, when executed by the processor, cause the processor to determine, by system software of the compute device, that a virtual machine requires a high QoS for cache of address translation in the offload device; receive a request from the system software on the compute device to implement a virtual machine-specific ATC reservation policy in the offload device; and send the start ATC reservation descriptor to the offload device in response to receipt of the request to implement the virtual machine-specific ATC reservation policy in the offload device.

Example 18 includes the subject matter of Example 17, and wherein the plurality of instructions further cause the processor to send a message to an input/output memory management unit (IOMMU) that requests an indication of capability of the IOMMU; and receive a message from the IOMMU that indicates that the IOMMU is capable of supporting descriptors that facilitate ATC reservation.

Example 19 includes the subject matter of any of Examples 17 and 18, and wherein the plurality of instructions further cause the processor to send a message to the offload device that requests an indication of capability of the offload device; and receive a message from the offload device that indicates that the offload device is capable of supporting ATC reservation.

Example 20 includes the subject matter of any of Examples 17-19, and wherein the plurality of instructions further cause the processor to determine, by the system software, that the virtual machine no longer requires a high QoS for cache of address translation in the offload device; receive a request from the system software on the compute device to stop implementation of the virtual machine-specific ATC reservation policy in the offload device; and send a stop ATC reservation descriptor to the offload device in response to receipt of the request to stop implementation of the virtual machine-specific ATC reservation policy in the offload device.

Example 21 includes the subject matter of any of Examples 17-20, and wherein to determine that the virtual machine requires a high QoS for cache of address translation in the offload device comprises to determine that the virtual machine or a container in the virtual machine is running a high-priority, critical, or real-time workload.

Example 22 includes a method comprising receiving, by an offload device, a start address translation cache (ATC) reservation descriptor, wherein the start ATC reservation descriptor comprises an identifier associated with a virtual machine; receiving, by the offload device, an address translation, wherein the address translation comprises a physical address corresponding to a translation of a virtual address; determining, by the offload device, that the address translation is associated with the identifier included in the start ATC reservation descriptor; and storing, by the offload device, the physical address in an ATC of the offload device, at least partially based on the determination that the address translation is associated with the identifier included in the start ATC reservation descriptor.

Example 23 includes the subject matter of Example 22, and further including sending, by the offload device and in response to receipt of a capability request message, a message indicating that the offload device is capable of reserving at least part of the ATC for cache entries associated with the ATC.

Example 24 includes the subject matter of any of Examples 22 and 23, and wherein the identifier associated with the virtual machine comprises a domain identifier, wherein the domain identifier identifies the virtual machine.

Example 25 includes the subject matter of any of Examples 22-24, and wherein the identifier associated with the virtual machine comprises a process address space identifier (PASID), wherein the PASID identifies an application of the virtual machine.

Example 26 includes the subject matter of any of Examples 22-25, and wherein the start ATC reservation descriptor comprises one or more flags that indicate whether the identifier associated with the virtual machine is a domain identifier that identifies the virtual machine or a process address space identifier (PASID) that identifies an application of the virtual machine.

Example 27 includes the subject matter of any of Examples 22-26, and further including, in response to receipt of the start ATC reservation descriptor storing, by the offload device, the identifier associated with the virtual machine in a register of the offload device; and establishing, by the offload device, a first zone and a second zone in the ATC, wherein the first zone is reserved for cache entries associated with the identifier.

Example 28 includes the subject matter of any of Examples 22-27, and further including evicting, by the offload device and in response to receipt of the start ATC reservation descriptor, one or more cache entries that are not associated with the identifier from the first zone.

Example 29 includes the subject matter of any of Examples 22-28, and further including storing, by the offload device, the physical address in the first zone of the ATC based on the determination that the address translation is associated with the identifier included in the start ATC reservation descriptor.

Example 30 includes the subject matter of any of Examples 22-29, and further including receiving, by the offload device, a second address translation, wherein the second address translation comprises a second physical address corresponding to a translation of a second virtual address; determining, by the offload device, that the second address translation is not associated with the identifier included in the start ATC reservation descriptor; and storing, by the offload device, the second physical address in the second zone based on the determination that the address translation is not associated with the identifier included in the start ATC reservation descriptor.

Example 31 includes the subject matter of any of Examples 22-30, and wherein the start ATC reservation descriptor includes one or more level bits, wherein the one or more level bits indicate a fraction of the ATC that should be reserved for cache entries associated with the identifier, wherein establishing the first zone in the ATC comprises establishing the first zone in the ATC based on the one or more level bits.

Example 32 includes the subject matter of any of Examples 22-31, and wherein the one or more level bits indicate that the first zone should be 25% of the ATC.

Example 33 includes the subject matter of any of Examples 22-32, and wherein the one or more level bits indicate that the first zone should be 50% of the ATC.

Example 34 includes the subject matter of any of Examples 22-33, and further including receiving, by the offload device, a stop ATC reservation descriptor; deleting, by the offload device and in response to receipt of the stop ATC reservation descriptor, the identifier associated with the virtual machine from the register; and merging, by the offload device and in response to receipt of the stop ATC reservation descriptor, the first zone and the second zone.

Example 35 includes the subject matter of any of Examples 22-34, and wherein storing the physical address in the ATC at least partially based on the determination that the address translation is associated with the identifier included in the start ATC reservation descriptor comprises preferentially evicting a cache entry from the ATC based on a determination that the cache entry is not associated with the identifier included in the start ATC reservation descriptor.

Example 36 includes the subject matter of any of Examples 22-35, and further including receiving, by the offload device, a second ATC reservation descriptor; determining, by the offload device, whether the second ATC reservation descriptor triggers an error; and sending, by the offload device, a message to an input/output memory management unit (MMU) in response to a determination that the second ATC reservation descriptor triggers an error.

Example 37 includes the subject matter of any of Examples 22-36, and further including determining, by system software of a compute device, that a virtual machine requires a high QoS for cache of address translation in the offload device; receiving, by the compute device, a request from the system software on the compute device to implement a virtual machine-specific ATC reservation policy in the offload device; and sending, by the compute device, the start ATC reservation descriptor to the offload device in response to receipt of the request to implement the virtual machine-specific ATC reservation policy in the offload device.

Example 38 includes the subject matter of any of Examples 22-37, and further including sending, by the compute device, a message to an input/output memory management unit (IOMMU) that requests an indication of capability of the IOMMU; and receiving, by the compute device, a message from the IOMMU that indicates that the IOMMU is capable of supporting descriptors that facilitate ATC reservation.

Example 39 includes the subject matter of any of Examples 22-38, and further including sending, by the compute device, a message to the offload device that requests an indication of capability of the offload device; and receiving, by the compute device, a message from the offload device that indicates that the offload device is capable of supporting ATC reservation.

Example 40 includes the subject matter of any of Examples 22-39, and further including determining, by the system software, that the virtual machine no longer requires a high QoS for cache of address translation in the offload device; receiving, by the compute device, a request from the system software on the compute device to stop implementation of the virtual machine-specific ATC reservation policy in the offload device; and sending, by the compute device, a stop ATC reservation descriptor to the offload device in response to receipt of the request to stop implementation of the virtual machine-specific ATC reservation policy in the offload device.

Example 41 includes an offload device comprising means for receiving a start address translation cache (ATC) reservation descriptor, wherein the start ATC reservation descriptor comprises an identifier associated with a virtual machine; means for receiving an address translation, wherein the address translation comprises a physical address corresponding to a translation of a virtual address; means for determining that the address translation is associated with the identifier included in the start ATC reservation descriptor; and means for storing the physical address in an ATC of the offload device, at least partially based on the determination that the address translation is associated with the identifier included in the start ATC reservation descriptor.

Example 42 includes the subject matter of Example 41, and further including means for sending, in response to receipt of a capability request message, a message indicating that the offload device is capable of reserving at least part of the ATC for cache entries associated with the ATC.

Example 43 includes the subject matter of any of Examples 41 and 42, and wherein the identifier associated with the virtual machine comprises a domain identifier, wherein the domain identifier identifies the virtual machine.

Example 44 includes the subject matter of any of Examples 41-43, and wherein the identifier associated with the virtual machine comprises a process address space identifier (PASID), wherein the PASID identifies an application of the virtual machine.

Example 45 includes the subject matter of any of Examples 41-44, and wherein the start ATC reservation descriptor comprises one or more flags that indicate whether the identifier associated with the virtual machine is a domain identifier that identifies the virtual machine or a process address space identifier (PASID) that identifies an application of the virtual machine.

Example 46 includes the subject matter of any of Examples 41-45, and further including, in response to receipt of the start ATC reservation descriptor means for storing the identifier associated with the virtual machine in a register of the offload device; and means for establishing a first zone and a second zone in the ATC, wherein the first zone is reserved for cache entries associated with the identifier.

Example 47 includes the subject matter of any of Examples 41-46, and further including means for evicting, in response to receipt of the start ATC reservation descriptor, one or more cache entries that are not associated with the identifier from the first zone.

Example 48 includes the subject matter of any of Examples 41-47, and further including means for storing the physical address in the first zone of the ATC based on the determination that the address translation is associated with the identifier included in the start ATC reservation descriptor.

Example 49 includes the subject matter of any of Examples 41-48, and further including means for receiving a second address translation, wherein the second address translation comprises a second physical address corresponding to a translation of a second virtual address; means for determining that the second address translation is not associated with the identifier included in the start ATC reservation descriptor; and means for storing the second physical address in the second zone based on the determination that the address translation is not associated with the identifier included in the start ATC reservation descriptor.

Example 50 includes the subject matter of any of Examples 41-49, and wherein the start ATC reservation descriptor includes one or more level bits, wherein the one or more level bits indicate a fraction of the ATC that should be reserved for cache entries associated with the identifier, wherein the means for establishing the first zone in the ATC comprises means for establishing the first zone in the ATC based on the one or more level bits.

Example 51 includes the subject matter of any of Examples 41-50, and wherein the one or more level bits indicate that the first zone should be 25% of the ATC.

Example 52 includes the subject matter of any of Examples 41-51, and wherein the one or more level bits indicate that the first zone should be 50% of the ATC.

Example 53 includes the subject matter of any of Examples 41-52, and further including means for receiving a stop ATC reservation descriptor; means for deleting, in response to receipt of the stop ATC reservation descriptor, the identifier associated with the virtual machine from the register; and means for merging, in response to receipt of the stop ATC reservation descriptor, the first zone and the second zone.

Example 54 includes the subject matter of any of Examples 41-53, and wherein the means for storing the physical address in the ATC at least partially based on the determination that the address translation is associated with the identifier included in the start ATC reservation descriptor comprises preferentially evicting a cache entry from the ATC based on a determination that the cache entry is not associated with the identifier included in the start ATC reservation descriptor.

Example 55 includes the subject matter of any of Examples 41-54, and further including means for receiving a second ATC reservation descriptor; means for determining whether the second ATC reservation descriptor triggers an error; and means for sending a message to an input/output memory management unit (MMU) in response to a determination that the second ATC reservation descriptor triggers an error.

Example 56 includes a compute device comprising the offload device of any of Examples 41-55, further comprising means for determining, by system software of the compute device, that a virtual machine requires a high QoS for cache of address translation in the offload device; means for receiving a request from the system software on the compute device to implement a virtual machine-specific ATC reservation policy in the offload device; and means for sending the start ATC reservation descriptor to the offload device in response to receipt of the request to implement the virtual machine-specific ATC reservation policy in the offload device.

Example 57 includes the subject matter of Example 56, and further including means for sending a message to an input/output memory management unit (IOMMU) that requests an indication of capability of the IOMMU; and means for receiving a message from the IOMMU that indicates that the IOMMU is capable of supporting descriptors that facilitate ATC reservation.

Example 58 includes the subject matter of any of Examples 56 and 57, and further including means for sending a message to the offload device that requests an indication of capability of the offload device; and means for receiving a message from the offload device that indicates that the offload device is capable of supporting ATC reservation.

Example 59 includes the subject matter of any of Examples 56-58, and further including means for determining, by the system software, that the virtual machine no longer requires a high QoS for cache of address translation in the offload device; means for receiving a request from the system software on the compute device to stop implementation of the virtual machine-specific ATC reservation policy in the offload device; and means for sending a stop ATC reservation descriptor to the offload device in response to receipt of the request to stop implementation of the virtual machine-specific ATC reservation policy in the offload device.

Example 60 includes one or more computer-readable media comprising a plurality of instructions stored thereon that, when executed, causes an offload device of a compute device to receive a start address translation cache (ATC) reservation descriptor, wherein the start ATC reservation descriptor comprises an identifier associated with a virtual machine; receive an address translation, wherein the address translation comprises a physical address corresponding to a translation of a virtual address; determine that the address translation is associated with the identifier included in the start ATC reservation descriptor; and store the physical address in the ATC at least partially based on the determination that the address translation is associated with the identifier included in the start ATC reservation descriptor.

Example 61 includes the subject matter of Example 60, and wherein the plurality of instructions further cause the offload device to send, in response to receipt of a capability request message, a message indicating that the offload device is capable of reserving at least part of the ATC for cache entries associated with the ATC.

Example 62 includes the subject matter of any of Examples 60 and 61, and wherein the identifier associated with the virtual machine comprises a domain identifier, wherein the domain identifier identifies the virtual machine.

Example 63 includes the subject matter of any of Examples 60-62, and wherein the identifier associated with the virtual machine comprises a process address space identifier (PASID), wherein the PASID identifies an application of the virtual machine.

Example 64 includes the subject matter of any of Examples 60-63, and wherein the start ATC reservation descriptor comprises one or more flags that indicate whether the identifier associated with the virtual machine is a domain identifier that identifies the virtual machine or a process address space identifier (PASID) that identifies an application of the virtual machine.

Example 65 includes the subject matter of any of Examples 60-64, and wherein the plurality of instructions further cause the offload device to, in response to receipt of the start ATC reservation descriptor store the identifier associated with the virtual machine in a register of the offload device; and establish a first zone and a second zone in the ATC, wherein the first zone is reserved for cache entries associated with the identifier.

Example 66 includes the subject matter of any of Examples 60-65, and wherein the plurality of instructions further cause the offload device to, in response to receipt of the start ATC reservation descriptor, evict, from the first zone, one or more cache entries that are not associated with the identifier.

Example 67 includes the subject matter of any of Examples 60-66, and wherein the plurality of instructions further cause the offload device to store the physical address in the first zone of the ATC based on the determination that the address translation is associated with the identifier included in the start ATC reservation descriptor.

Example 68 includes the subject matter of any of Examples 60-67, and wherein the plurality of instructions further cause the offload device to receive a second address translation, wherein the second address translation comprises a second physical address corresponding to a translation of a second virtual address; determine that the second address translation is not associated with the identifier included in the start ATC reservation descriptor; and store the second physical address in the second zone based on the determination that the address translation is not associated with the identifier included in the start ATC reservation descriptor.

Example 69 includes the subject matter of any of Examples 60-68, and wherein the start ATC reservation descriptor includes one or more level bits, wherein the one or more level bits indicate a fraction of the ATC that should be reserved for cache entries associated with the identifier, wherein to establish the first zone in the ATC comprises to establish the first zone in the ATC based on the one or more level bits.

Example 70 includes the subject matter of any of Examples 60-69, and wherein the one or more level bits indicate that the first zone should be 25% of the ATC.

Example 71 includes the subject matter of any of Examples 60-70, and wherein the one or more level bits indicate that the first zone should be 50% of the ATC.

Example 72 includes the subject matter of any of Examples 60-71, and wherein the plurality of instructions further cause the offload device to receive a stop ATC reservation descriptor; delete, in response to receipt of the stop ATC reservation descriptor, the identifier associated with the virtual machine from the register; and merge, in response to receipt of the stop ATC reservation descriptor, the first zone and the second zone.

Example 73 includes the subject matter of any of Examples 60-72, and wherein to store the physical address in the ATC at least partially based on the determination that the address translation is associated with the identifier included in the start ATC reservation descriptor comprises to preferentially evict a cache entry from the ATC based on a determination that the cache entry is not associated with the identifier included in the start ATC reservation descriptor.

Example 74 includes the subject matter of any of Examples 60-73, and wherein the plurality of instructions further cause the offload device to receive a second ATC reservation descriptor; determine whether the second ATC reservation descriptor triggers an error; and send a message to an input/output memory management unit (MMU) in response to a determination that the second ATC reservation descriptor triggers an error.

Example 75 includes the subject matter of any of Examples 60-74, and wherein the plurality of instructions further cause the compute device to determine, by system software of the compute device, that a virtual machine requires a high QoS for cache of address translation in the offload device; receive a request from the system software on the compute device to implement a virtual machine-specific ATC reservation policy in the offload device; and send the start ATC reservation descriptor to the offload device in response to receipt of the request to implement the virtual machine-specific ATC reservation policy in the offload device.

Example 76 includes the subject matter of any of Examples 60-75, and wherein the plurality of instructions further cause the compute device to send a message to an input/output memory management unit (IOMMU) that requests an indication of capability of the IOMMU; and receive a message from the IOMMU that indicates that the IOMMU is capable of supporting descriptors that facilitate ATC reservation.

Example 77 includes the subject matter of any of Examples 60-76, and wherein the plurality of instructions further cause the compute device to send a message to the offload device that requests an indication of capability of the offload device; and receive a message from the offload device that indicates that the offload device is capable of supporting ATC reservation.

Example 78 includes the subject matter of any of Examples 60-77, and wherein the plurality of instructions further cause the compute device to determine, by the system software, that the virtual machine no longer requires a high QoS for cache of address translation in the offload device; receive a request from the system software on the compute device to stop implementation of the virtual machine-specific ATC reservation policy in the offload device; and send a stop ATC reservation descriptor to the offload device in response to receipt of the request to stop implementation of the virtual machine-specific ATC reservation policy in the offload device.

Example 79 includes a compute device comprising a processor; one or more computer-readable media comprising a plurality of instructions stored thereon that, when executed by the processor, cause the processor to determine, by system software of the compute device, that a virtual machine requires a high QoS for address translation cache (ATC) in an offload device; receive a request from the system software on the compute device to implement a virtual machine-specific ATC reservation policy in the offload device; and send a start ATC reservation descriptor to the offload device in response to receipt of the request to implement the virtual machine-specific ATC reservation policy in the offload device.

Example 80 includes the subject matter of Example 79, and wherein the plurality of instructions further cause the processor to send a message to an input/output memory management unit (IOMMU) that requests an indication of capability of the IOMMU; and receive a message from the IOMMU that indicates that the IOMMU is capable of supporting descriptors that facilitate ATC reservation.

Example 81 includes the subject matter of any of Examples 79 and 80, and wherein the plurality of instructions further cause the processor to send a message to the offload device that requests an indication of capability of the offload device; and receive a message from the offload device that indicates that the offload device is capable of supporting ATC reservation.

Example 82 includes the subject matter of any of Examples 79-81, and wherein the plurality of instructions further cause the processor to determine, by the system software, that the virtual machine no longer requires a high QoS for ATC in the offload device; receive a request from the system software on the compute device to stop implementation of the virtual machine-specific ATC reservation policy in the offload device; and send a stop ATC reservation descriptor to the offload device in response to receipt of the request to stop implementation of the virtual machine-specific ATC reservation policy in the offload device.

Example 83 includes a method comprising determining, by system software of a compute device, that a virtual machine requires a high QoS for address translation cache (ATC) in an offload device; receiving, by the compute device, a request from the system software on the compute device to implement a virtual machine-specific ATC reservation policy in the offload device; and sending, by the compute device, a start ATC reservation descriptor to the offload device in response to receipt of the request to implement the virtual machine-specific ATC reservation policy in the offload device.

Example 84 includes the subject matter of Example 83, and further including sending, by the compute device, a message to an input/output memory management unit (IOMMU) that requests an indication of capability of the IOMMU; and receiving, by the compute device, a message from the IOMMU that indicates that the IOMMU is capable of supporting descriptors that facilitate ATC reservation.

Example 85 includes the subject matter of any of Examples 83 and 84, and further including sending, by the compute device, a message to the offload device that requests an indication of capability of the offload device; and receiving, by the compute device, a message from the offload device that indicates that the offload device is capable of supporting ATC reservation.

Example 86 includes the subject matter of any of Examples 83-85, and further including determining, by the system software, that the virtual machine no longer requires a high QoS for ATC in the offload device; receiving, by the compute device, a request from the system software on the compute device to stop implementation of the virtual machine-specific ATC reservation policy in the offload device; and sending, by the compute device, a stop ATC reservation descriptor to the offload device in response to receipt of the request to stop implementation of the virtual machine-specific ATC reservation policy in the offload device.

Example 87 includes a compute device comprising means for determining, by system software of the compute device, that a virtual machine requires a high QoS for address translation cache (ATC) in an offload device; means for receiving a request from the system software on the compute device to implement a virtual machine-specific ATC reservation policy in the offload device; and means for sending a start ATC reservation descriptor to the offload device in response to receipt of the request to implement the virtual machine-specific ATC reservation policy in the offload device.

Example 88 includes the subject matter of Example 87, and further including means for sending a message to an input/output memory management unit (IOMMU) that requests an indication of capability of the IOMMU; and means for receiving a message from the IOMMU that indicates that the IOMMU is capable of supporting descriptors that facilitate ATC reservation.

Example 89 includes the subject matter of any of Examples 87 and 88, and further including means for sending a message to the offload device that requests an indication of capability of the offload device; and means for receiving a message from the offload device that indicates that the offload device is capable of supporting ATC reservation.

Example 90 includes the subject matter of any of Examples 87-89, and further including means for determining, by the system software, that the virtual machine no longer requires a high QoS for ATC in the offload device; means for receiving a request from the system software on the compute device to stop implementation of the virtual machine-specific ATC reservation policy in the offload device; and means for sending a stop ATC reservation descriptor to the offload device in response to receipt of the request to stop implementation of the virtual machine-specific ATC reservation policy in the offload device.

Example 91 includes one or more computer-readable media comprising a plurality of instructions stored thereon that, when executed, causes a processor of a compute device to determine, by system software of the compute device, that a virtual machine requires a high QoS for address translation cache (ATC) in an offload device; receive a request from the system software on the compute device to implement a virtual machine-specific ATC reservation policy in the offload device; and send a start ATC reservation descriptor to the offload device in response to receipt of the request to implement the virtual machine-specific ATC reservation policy in the offload device.

Example 92 includes the subject matter of Example 91, and wherein the plurality of instructions further cause the processor to send a message to an input/output memory management unit (IOMMU) that requests an indication of capability of the IOMMU; and receive a message from the IOMMU that indicates that the IOMMU is capable of supporting descriptors that facilitate ATC reservation.

Example 93 includes the subject matter of any of Examples 91 and 92, and wherein the plurality of instructions further cause the processor to send a message to the offload device that requests an indication of capability of the offload device; and receive a message from the offload device that indicates that the offload device is capable of supporting ATC reservation.

Example 94 includes the subject matter of any of Examples 91-93, and wherein the plurality of instructions further cause the processor to determine, by the system software, that the virtual machine no longer requires a high QoS for ATC in the offload device; receive a request from the system software on the compute device to stop implementation of the virtual machine-specific ATC reservation policy in the offload device; and send a stop ATC reservation descriptor to the offload device in response to receipt of the request to stop implementation of the virtual machine-specific ATC reservation policy in the offload device.

1. An offload device comprising:
an address translation cache (ATC); and
a processing engine implemented at least partially in hardware, wherein the processing engine is to:
receive a start ATC reservation descriptor, wherein the start ATC reservation descriptor comprises an identifier associated with a virtual machine;
receive an address translation, wherein the address translation comprises a physical address corresponding to a translation of a virtual address;
determine that the address translation is associated with the identifier included in the start ATC reservation descriptor; and
store the physical address in the ATC at least partially based on the determination that the address translation is associated with the identifier included in the start ATC reservation descriptor.

2. The offload device of claim 1, wherein the identifier associated with the virtual machine comprises a domain identifier, wherein the domain identifier identifies the virtual machine.

3. The offload device of claim 1, wherein the identifier associated with the virtual machine comprises a process address space identifier (PASID), wherein the PASID identifies an application of the virtual machine.

4. The offload device of claim 1, wherein the start ATC reservation descriptor comprises one or more flags that indicate whether the identifier associated with the virtual machine is a domain identifier that identifies the virtual machine or a process address space identifier (PASID) that identifies an application of the virtual machine.

5. The offload device of claim 1, wherein, in response to receipt of the start ATC reservation descriptor, the processing engine is to:
store the identifier associated with the virtual machine in a register of the offload device; and
establish a first zone and a second zone in the ATC, wherein the first zone is reserved for cache entries associated with the identifier.

6. The offload device of claim 5, wherein, in response to receipt of the start ATC reservation descriptor, the processing engine is to evict, from the first zone, one or more cache entries that are not associated with the identifier.

7. The offload device of claim 5, wherein the processing engine is to store the physical address in the first zone of the ATC based on the determination that the address translation is associated with the identifier included in the start ATC reservation descriptor.

8. The offload device of claim 5, wherein the processing engine is further to:
receive a second address translation, wherein the second address translation comprises a second physical address corresponding to a translation of a second virtual address;
determine that the second address translation is not associated with the identifier included in the start ATC reservation descriptor; and
store the second physical address in the second zone based on the determination that the address translation is not associated with the identifier included in the start ATC reservation descriptor.

9. The offload device of claim 5, wherein the start ATC reservation descriptor includes one or more level bits, wherein the one or more level bits indicate a fraction of the ATC that should be reserved for cache entries associated with the identifier,
wherein to establish the first zone in the ATC comprises to establish the first zone in the ATC based on the one or more level bits.

10. The offload device of claim 9, wherein the one or more level bits indicate that the first zone should be 25% of the ATC.

11. The offload device of claim 9, wherein the one or more level bits indicate that the first zone should be 50% of the ATC.

12. The offload device of claim 5, wherein the processing engine in further to:
receive a stop ATC reservation descriptor;
delete, in response to receipt of the stop ATC reservation descriptor, the identifier associated with the virtual machine from the register; and
merge, in response to receipt of the stop ATC reservation descriptor, the first zone and the second zone.

13. The offload device of claim 1, wherein to store the physical address in the ATC at least partially based on the determination that the address translation is associated with the identifier included in the start ATC reservation descriptor comprises to preferentially evict a cache entry from the ATC based on a determination that the cache entry is not associated with the identifier included in the start ATC reservation descriptor.

14. The offload device of claim 1, wherein the processing engine in further to:
receive a second ATC reservation descriptor;
determine whether the second ATC reservation descriptor triggers an error; and
send a message to an input/output memory management unit (MMU) in response to a determination that the second ATC reservation descriptor triggers an error.

15. The offload device of claim 1, wherein the processing engine in further to:
receive a second ATC reservation descriptor;
determine whether the second ATC reservation descriptor triggers an error; and
send a completion record in response to receipt of the second ATC reservation descriptor, wherein the completion record includes a status code indicative of the error.

16. A compute device comprising the offload device of claim 1, further comprising:
a processor;
one or more computer-readable media comprising a plurality of instructions stored thereon that, when executed by the processor, cause the processor to:
determine, by system software of the compute device, that a virtual machine requires a high QoS for cache of address translation in the offload device;
receive a request from the system software on the compute device to implement a virtual machine-specific ATC reservation policy in the offload device; and
send the start ATC reservation descriptor to the offload device in response to receipt of the request to implement the virtual machine-specific ATC reservation policy in the offload device.

17. The compute device of claim 16, wherein to determine that the virtual machine requires a high QoS for cache of address translation in the offload device comprises to determine that the virtual machine or a container in the virtual machine is running a high-priority, critical, or real-time workload.

18. A method comprising:
receiving, by an offload device, a start address translation cache (ATC) reservation descriptor, wherein the start ATC reservation descriptor comprises an identifier associated with a virtual machine;
receiving, by the offload device, an address translation, wherein the address translation comprises a physical address corresponding to a translation of a virtual address;
determining, by the offload device, that the address translation is associated with the identifier included in the start ATC reservation descriptor; and
storing, by the offload device, the physical address in an ATC of the offload device, at least partially based on the determination that the address translation is associated with the identifier included in the start ATC reservation descriptor.

19. The method of claim 18, further comprising, in response to receipt of the start ATC reservation descriptor:
storing, by the offload device, the identifier associated with the virtual machine in a register of the offload device; and
establishing, by the offload device, a first zone and a second zone in the ATC, wherein the first zone is reserved for cache entries associated with the identifier.

20. The method of claim 19, further comprising evicting, by the offload device and in response to receipt of the start ATC reservation descriptor, one or more cache entries that are not associated with the identifier from the first zone.

21. The method of claim 18, further comprising:
determining, by system software of a compute device, that a virtual machine requires a high QoS for cache of address translation in the offload device;
receiving, by the compute device, a request from the system software on the compute device to implement a virtual machine-specific ATC reservation policy in the offload device; and
sending, by the compute device, the start ATC reservation descriptor to the offload device in response to receipt of the request to implement the virtual machine-specific ATC reservation policy in the offload device.

22. An offload device comprising:
means for receiving a start address translation cache (ATC) reservation descriptor, wherein the start ATC reservation descriptor comprises an identifier associated with a virtual machine;
means for receiving an address translation, wherein the address translation comprises a physical address corresponding to a translation of a virtual address;
means for determining that the address translation is associated with the identifier included in the start ATC reservation descriptor; and
means for storing the physical address in an ATC of the offload device, at least partially based on the determination that the address translation is associated with the identifier included in the start ATC reservation descriptor.

23. The offload device of claim 22, further comprising, in response to receipt of the start ATC reservation descriptor:
means for storing the identifier associated with the virtual machine in a register of the offload device; and
means for establishing a first zone and a second zone in the ATC, wherein the first zone is reserved for cache entries associated with the identifier.

24. The offload device of claim 23, further comprising means for storing the physical address in the first zone of the ATC based on the determination that the address translation is associated with the identifier included in the start ATC reservation descriptor.

25. A compute device comprising the offload device of claim 22, further comprising:
means for determining, by system software of the compute device, that a virtual machine requires a high QoS for cache of address translation in the offload device;
means for receiving a request from the system software on the compute device to implement a virtual machine-specific ATC reservation policy in the offload device; and
means for sending the start ATC reservation descriptor to the offload device in response to receipt of the request to implement the virtual machine-specific ATC reservation policy in the offload device.
